(19) United States
(12) Patent Application Publication
(10) Pub. No.: US 2025/0341030 A1
(43) Pub. Date: Nov. 6, 2025

(54) A DICHLOROMETHANE FREE PROCESS FOR MAKING CELLULOSE TRIACETATE FIBER

(71) Applicant: Eastman Chemical Company, Kingsport, TN (US)

(72) Inventors: Marcus David Shelby, Fall Branch, TN (US); Freddie Wayne Williams, Kingsport, TN (US); Mark Edward Stewart, Kingsport, TN (US); James Collins Maine, Church Hill, TN (US); John Michael Allen, Kingsport, TN (US); Weijun Kevin Wang, Kingsport, TN (US); Yan Jin, Johnson City, TN (US)

(73) Assignee: Eastman Chemical Company, Kingsport, TN (US)

(21) Appl. No.: 18/870,877

(22) PCT Filed: Jun. 1, 2023
(86) PCT No.: PCT/US2023/067732

§ 371 Date: Dec. 2, 2024

Related U.S. Application Data
(60) Provisional application No. 63/365,783, filed on Jun. 3, 2022.

(51) Int. Cl. D01F 2/28; D01D 5/06; D01D 10/02; D01G 1/04; D02G 1/12; D02J 1/22

(52) U.S. Cl. CPC D01F 2/28; D01D 5/06; D01D 10/02; D01G 1/04; D02G 1/12; D02J 1/223; D10B 2201/28; D10B 2401/063

(57) ABSTRACT

A dichloromethane-free wet spinning process for producing cellulose triacetate fiber with a silk factor greater than 8.0. A dichloromethane-free cellulose triacetate dope comprising dimethylacetamide is wet spun into a coagulation bath which is controlled to a temperature ranging from 20° C. to 40° C. and comprising dimethylacetamide and water. A jet draw stretching ratio ranging from 0.3 to 1.4 is applied to the wet spun CTA fibers which may also be subjected to one or more post jet draw stretching steps. During drying, the CTA fibers are partially or completely shrunk. This process enables CTA fiber(s) having a silk factor greater than 8.0 to be produced without using dichloromethane and without the energy costs associated with other processes that requiring lower or higher coagulation bath temperatures.

### FIELD OF THE INVENTION

The present invention relates to a dichloromethane-free wet spinning process for manufacturing cellulose triacetate fibers having a silk factor of at least 8.0.

### BACKGROUND OF THE INVENTION

Cellulose triacetate (CTA) fiber has unique properties that make it highly desirable for textile applications. CTA has a degree of crystallinity and a low modulus that enable a silk-like feel with better “wash and wear” characteristics (i.e. better pleat retention and lower moisture absorption) than other cellulose based polymers such as cellulose diacetate or viscose. Unfortunately, the crystallinity and polarity properties of cellulose triacetate render it insoluble in all but the most aggressive solvents.

Historically, dichloromethane (DCM), also known as methylene chloride, and blends of DCM with an alcohol such as methanol and/or ethanol have served as the primary solvent systems utilized in dissolving CTA for the purpose of producing CTA fibers having acceptable tensile strength and elongation. However, environmental, health, and regulatory issues have greatly curtailed the use of DCM-based solvent systems. Other solvents have been evaluated as alternatives to DCM, but such evaluations have typically resulted in the production of CTA fibers with insufficient tensile strength, elongation at break, or silk factor. Many DCM-free processes for producing CTA fibers require low temperature coagulation baths that require chilling and/or insulation as well as high temperature washing steps to remove residual solvent. These approaches are more expensive to operate because of the energy required to chill and/or heat such process steps and are difficult if not impossible to retrofit to existing processes.

The manufacturing processes of knitting and weaving yarns into textiles involve equipment and processing steps that subject the yarns to stresses and strains that can cause yarn breakage with weak fibers or yarns. Breakages result in process downtime, yield losses, and off quality product. Tensile strength and Elongation at Break (elongation) are two properties of a yarn that help determine the suitability of the yarn for use in a given textile process or with a given piece of equipment.

Tenacity is a measurement of the force required to break a fiber or yarn at a given denier or dtex and is typically expressed in units of g/den, g/dtex, or N/dtex. One technique to increase the tenacity of CTA fibers and yarns is to utilize CTA polymer with a higher degree of polymerization (DP) because higher DP CTA polymer typically yields higher tenacity CTA fibers. A common problem with this approach is that higher DP CTA polymer tends to produce more viscous CTA dope that can be difficult to filter and spin, especially at high speeds or large volumes. The issue of high viscosity dope can be especially problematic when working with dichloromethane free solvent systems. An alternative means to increase the CTA fiber or yarn tenacity without using higher DP CTA polymer involves drawing or stretching the coagulated fiber. Stretching/stressing the fiber can impart some degree of orientation which translates to increased tenacity. The problem with increasing tenacity by drawing is that the resulting increase in orientation decreases the ductility of the fiber, resulting in lower elongation.

Elongation, also known as elongation at break, is the ratio of the increase in the length of a yarn or fiber sample at the point that it breaks under tensile load versus the length of the sample before the load was applied. Elongation is expressed as a percentage and it is indicative of how much a yarn or fiber will stretch before breaking. As noted above, drawing coagulated CTA fibers in order to improve tenacity also lowers elongation.

Silk Factor (SF) is an empirically determined relationship between tenacity and elongation that is used to predict the failure envelope of a given fiber. SF can be used to characterize the suitability of a fiber or a yarn for use in a given process. Silk Factor is herein calculated as SF=tenacity×\sqrt{elongation} where tenacity is in units of g/den and elongation is expressed as a percentage. CTA fiber produced from a DCM solvent system process can exhibit silk factor values in the 9-11 range with a minimum tenacity of 1.8-2.0 g/den and elongation in the 20-30% range. CTA yarn produced from a DCM-free solvent system process typically exhibits silk factor values in the 6-7 range and are considered to be too weak for use in many textile processes.

There is a market need to improve the silk factor of cellulose triacetate fibers made in dichloromethane free processes so that the resulting CTA fiber can be processed into filament yarn or converted into staple fiber for ring spinning and/or non-woven application.

It would be beneficial to provide products having such properties from a process that does not utilize dichloromethane solvent systems which can contribute to operator health issues and environmental contamination concerns. It would also be beneficial to operate such a DCM-free process at or near ambient temperature at key process steps such as coagulation.

### SUMMARY OF THE INVENTION

In one or more aspects, the present invention concerns a process for producing cellulose triacetate fibers having a silk factor greater than or equal to 8.0 that includes:
a) a dissolving step wherein cellulose triacetate is dissolved in one or more dichloromethane-free dope solvents including at least dimethylacetamide to prepare a cellulose triacetate dope;
b) a wet spinning step wherein the cellulose triacetate dope is wet spun to form one or more cellulose triacetate fibers at a jet draw stretch ratio in the range of from 0.3 to 1.4 in a dichloromethane-free coagulation bath wherein the dichloromethane-free coagulation bath comprises dimethylacetamide and water and wherein the dichloromethane-free coagulation bath is maintained at a temperature range of 20° C. to 40° C.;
c) and a drying step wherein the one or more cellulose triacetate fibers are dried in a manner to allow the one or more cellulose triacetate fibers to shrink.

In one or more aspects, the present invention concerns a wet-spun cellulose triacetate fiber. Generally, the cellulose ester fiber exhibits a silk factor of at least 8.0. Furthermore, the cellulose ester fiber comprises a cellulose ester comprising a DS_{acetyl} of at least 2.6 and a number average degree of polymerization of not more than 200.

In one or more aspects, the present technology concerns a cellulose triacetate dope. Generally, the CTA dope comprises CTA is in one or more solvents comprising dimethylacetamide, dimethylformamide, or a combination thereof. Furthermore, the CTA comprises a DS_{acetyl} of at least 2.6 and a number average degree of polymerization of not more than 200. Moreover, the CTA dope exhibits a viscosity of not more than 1,000 poise when measured at 90° C.

### BRIEF DESCRIPTION OF THE DRAWINGS

Embodiments of the present invention are described herein with reference to the following drawing figures, wherein:

FIG. 1 depicts an exemplary wet spinning system according to one embodiment of the present application; and

FIG. 2 depicts a block diagram representing one possible arrangement of the steps of the claimed process.

FIG. 3 depicts the optimal coagulation bath concentrations.

FIG. 4 depicts the effects of drying on dpf.

FIG. 5 depicts the effects of drying conditions on elongation.

FIG. 6 depicts the effects of drying conditions on tenacity.

FIG. 7 depicts the effects of drying conditions on the silk factor.

FIG. 8 depicts the effects of jet draw stretch ratio on the silk factor.

### DETAILED DESCRIPTION OF THE INVENTION

The present application generally relates to a DCM-free wet spinning process for preparing a cellulose triacetate fiber. Such fibers can be utilized in downstream fiber converting and textile applications. Furthermore, such DCM-free CTA fibers may be produced by means of a wet spinning process. In such a process, the CTA is dissolved in a DCM-free solvent comprising dimethylacetamide and, optionally, one or more non-DCM solvents (e.g., dimethylformamide) to form a CTA dope. The resulting CTA dope is wet spun through a plurality of small holes in the submerged face of a spinneret directly into DCM-free coagulation bath comprising dimethylacetamide and water. The DCM-free coagulation bath solvent concentration and conditions may be optimized to affect solidification and fiber formation. The coagulation bath temperature is preferably maintained at or near ambient condition. Furthermore, the one or more CTA fibers are stretched in the DCM-free coagulation bath under specific jet draw stretching conditions (e.g., the ratio of fiber take-up velocity relative to the calculated velocity of the CTA dope as it exits the spinneret into the first coagulation bath) to impart desirable polymer orientation within the one or more CTA fibers as they are formed. The jet draw stretch ratio (JDSR) is calculated according to the formula:

$$J D S R = \frac{{v}_{2}}{{v}_{1}}$$

where v₁ is the velocity (m/min) of the fiber as it exits the spinneret face and v₂ is the velocity (m/min) of the fiber at the take-up roll. v₁ is calculated according to the formula:

$${v}_{1} = ( \frac{{F}_{dope}}{number of holes} \div {A}_{ih} )$$

where F_{dope} is the volumetric dope flow to the spinneret, the number of holes is the number of holes in the face of the spinneret, and Ain is the area of an individual hole. In addition, the one or more CTA fibers can also be further stretched after the first coagulation bath, thereby providing additional polymer orientation in a post jet draw stretching step or steps.

More particularly, the wet spinning process described herein produces a CTA fiber having a silk factor greater than or equal to 8.0 via wet spinning without the use of DCM-based solvent. Filtering the CTA dope enables improved processability as fibers are formed by the spinneret. The CTA that may be utilized in the present invention can have a lower degree of polymerization (“DP”) than traditionally higher DP CTA utilized in dichloromethane free wet spinning processes. Lower DP CTA may allow for the use of higher solids dopes, which in turn may increase the throughput of wet spinning processes and may enable better morphological properties during fiber formation in the first coagulation bath.

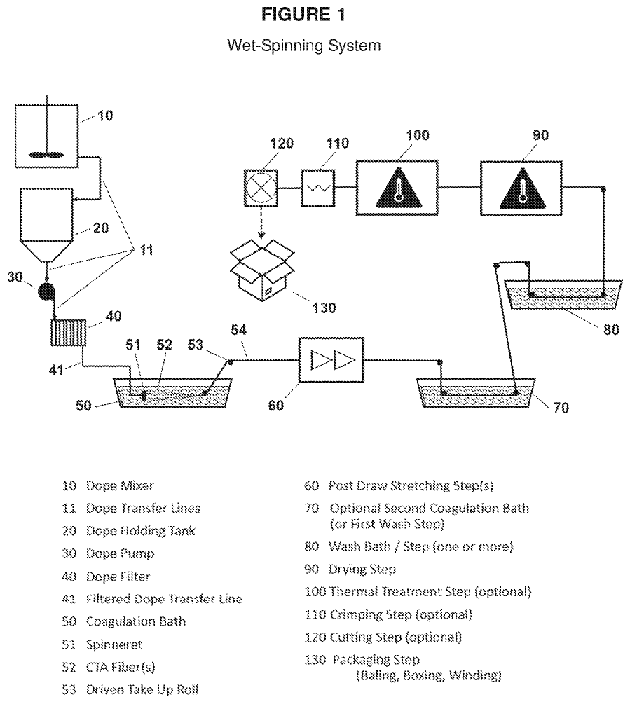

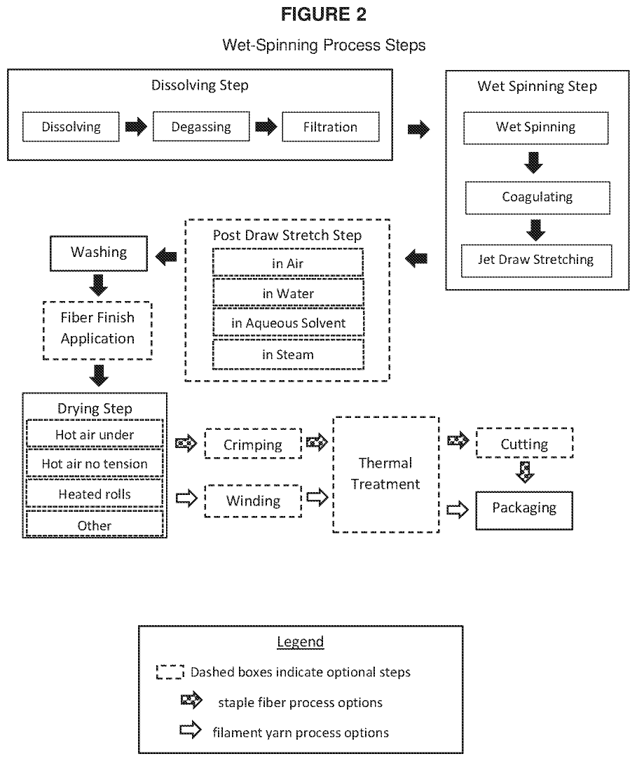

FIG. 1 depicts an exemplary wet spinning system for producing the CTA fiber. The depiction of FIG. 1 is a non-limiting example wherein certain features may be omitted and/or rearranged. Additional features described herein and in FIG. 2 may also be added to the system depicted in FIG. 1.

The wet spinning system of FIG. 1 and described herein may produce one or more CTA fibers that exhibit a silk factor greater than or equal to 8.0. The various characteristics and properties of the wet spinning process and resulting CTA fibers are described below. It should be noted that, while all of the following characteristics and properties may be listed separately, it is envisioned that each of the following characteristics and/or properties of the wet spinning process, CTA dope, and CTA fibers are not mutually exclusive and may be combined and present in any combination.

Turning to FIG. 1, in the dissolving step at least one cellulose ester and at least one dissolution solvent may be introduced into a dope mixer 10 so as to form the CTA dope. The dope mixer 10 can comprise any conventional device capable of mixing the CTA and the dissolution solvent. Exemplary dope mixers 10 can include a continuous stirred tank reactor (“CSTR”). While in the dope mixer 10, the CTA and dissolution solvent can be subjected to temperature and mixing conditions that facilitate the dissolution of the CTA into the dissolution solvent, thereby forming the CTA dope. For example, it is known in the art that some cellulose ester dopes can be prepared by first cooling the dope to lower temperature to allow the solvent to better intermix with the polymer, before heating up to a final mixing temperature. Alternately, some dope preparation processes prefer faster “flash” type heating to rapidly bring the system into solution with minimal degradation.

In one embodiment or in combination with any other mentioned embodiments, the CTA dope can comprise a solids content of at least 15, at least 16, at least 17, at least 18, at least 19, at least 20, at least 21, at least 22, or at least 23 weight percent and/or not more than 35, not more than 34, not more than 33, not more than 32, not more than 31, not more than 30, not more than 29, not more than 28, not more than 27, not more than 26, or not more than 25 weight percent, based on the total weight of the dope.

The CTA introduced into the dope mixer 10 can include any cellulose triacetate known in the art. Cellulose triacetates that can be used for the present invention generally comprise repeating units of the structure:

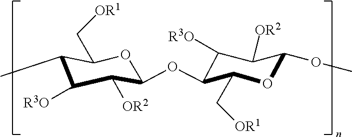

wherein R¹, R², and R³ are acetyl functional groups.

For cellulose ester polymers, the substitution level is usually expressed in terms of degree of substitution (“DS”), which is the average number of non-OH substituents per anhydroglucose unit (“AGU”). Generally, conventional cellulose contains three hydroxyl groups in each AGU unit that can be substituted; therefore, DS can have a value between zero and three. However, low molecular weight CTA can have a total degree of substitution slightly above 3 due to the presence of end groups. Because DS is a statistical mean value, a value of 1 does not assure that every AGU has a single substituent. In some cases, there can be unsubstituted AGU's, some with two and some with three substituents, and typically the value will be a non-integer. The “Total DS” is defined as the average number of all substituents per AGU. The degree of substitution per AGU can also refer to a particular substituent, such as, for example, hydroxyl, acetyl, proprionyl, or butyryl.

In one embodiment or in combination with any other mentioned embodiments, the CTA comprises a DS_{acetyl} of at least 2.60, at least 2.65, at least 2.70, at least 2.75, at least 2.80, at least 2.82, or at least 2.85 and/or not more than 3.00, not more than 2.99, not more than 2.95, not more than 2.9, or not more than 2.88 In certain embodiments, the CTA may comprise a DS_{acetyl} in the range of 2.60 to 3.00, 2.65 to 2.99, 2.70 to 2.95, 2.75 to 2.90, 2.80 to 2.88, 2.82 to 2.88, or 2.85 to 2.88.

Additionally or alternatively, in one embodiment or in combination with any other mentioned embodiments, the CTA comprises a DS_{OH} of at least 0.0, at least 0.01, at least 0.05, at least 0.10, or at least 0.12 and/or not more than 0.4, not more than 0.35, not more than 0.30, not more than 0.25, not more than 0.20, not more than 0.18, or not more than 0.15. In certain embodiments, the cellulose ester comprises a DS_{OH} in the range of 0.0 to 0.4, 0.01 to 0.35, 0.05 to 0.30, 0.10 to 0.25, 0.12 to 0.18, or 0.12 to 0.15.

In one embodiment or in combination with any other mentioned embodiments, the CTA can have a degree of acetylation of at least 56.2, at least 56.9, or at least 57.6 percent and/or not more than 61.5, not more than 61.0, not more than 60.3, not more than 59.7, or not more than 59 weight percent. In certain embodiments, the CTA may have a degree of acetylation in the range of 56.2 to 61.5, 56.9 to 61, 57.6 to 60.3 weight percent.

Additionally or alternatively, In one embodiment or in combination with any other mentioned embodiments, the CTA can have a hydroxyl content of at least 0, at least 0.3, at least 0.6, at least 0.9, or at least 1.2 weight percent and/or not more than 2.4, not more than 2.1, not more than 1.8, or not more than 1.5 weight percent. In certain embodiments, the CTA may have a hydroxyl content in the range of 0.0 to 2.4, 0.3 to 2.1, 0.6 to 1.8, or 0.9 to 1.5 weight percent.

In one embodiment or in combination with any other mentioned embodiments, the CTA can have a number average degree of polymerization of at least 90, at least 100, at least 110, at least 120, at least 130, at least 140, at least 150, or more than 150, or at least 151, or at least 153, or at least 155, or at least 160, at least 170, at least 180, at least 190, or at least 200. Additionally or alternatively, In one embodiment or in combination with any other mentioned embodiments, the CTA can have a number average degree of polymerization of not more than 300, or not more than 290, or not more than 280, or not more than 270, or not more than 260, or not more than 250, or not more than 240, or not more than 230, or not more than 220, or not more than 210, or not more than 200, or not more than 190, or not more than 180, or not more than 170, or not more than 160, or not more than 150, or not more than 149, or not more than 148, or not more than 147, or not more than 146, or not more than 145, or not more than 144, or not more than 143, or not more than 142, not more than 141, not more than 140, not more than 139, not more than 138, not more than 137, not more than 136, not more than 135, not more than 134, not more than 133, not more than 132, not more than 131, not more than 130, not more than 129, not more than 128, not more than 127, not more than 126, not more than 125, not more than 124, not more than 123, not more than 122, not more than 121, not more than 120, not more than 119, not more than 118, not more than 117, not more than 116, or not more than 115. In certain embodiments, the CTA can have a number average degree of polymerization in the range of 90 to 300, or 90 to 250, or 90 to 250, or 90 to 270, or 90 to 250, or 90 to 230, or 90 to 210, or 90 to 200, 90 to 190, 90 to 180, 90 to 170, 90 to 160, 90 to 150, 100 to 200, 100 to 190, 100 to 180, 100 to 170, 100 to 160, 100 to 150, or 90 to less than 150, or 90 to 149, or 90 to 147, or 90 to 145.

In one embodiment or in combination with any other mentioned embodiments, the CTA can comprise a number average absolute molecular weight of at least 10,000, at least 15,000, at least 20,000, or at least 25,000 and/or not more than 75,000, not more than 70,000, not more than 65,000, not more than 60,000, not more than 55,000, not more than 50,000, not more than 45,000, not more than 40,000, not more than 35,000, or not more than 30,000 as measured by absolute molecular weight via gel permeation chromatography (“GPC”). In certain embodiments, the CTA can comprise a number average absolute molecular weight in the range of 10,000 to 75,000, 10,000 to 65,000, or 15,000 to 35,000 as measured by absolute molecular weight via GPC.

In one embodiment or in combination with any other mentioned embodiments, the CTA can comprise a weight-average absolute molecular weight of at least 50,000, at least 55,000, at least 60,000, at least 65,000, at least 70,000, at least 75,000, at least 80,000, or at least 85,000 and/or not more than 150,000, not more than 140,000, not more than 130,000, not more than 120,000, not more than 110,000, not more than 100,000, or not more than 95,000 as measured by absolute molecular weight via GPC. In certain embodiments, the CTA can comprise a weight-average absolute molecular weight in the range of 50,000 to 150,000, 70,000 to 120,000, or 80,000 to 95,000 as measured by absolute molecular weight via GPC.

In one embodiment or in combination with any of the mentioned embodiments, the CTA can have any of the above-mentioned weight-average absolute molecular weights as measured under ASTM D6474.

In one embodiment or in combination with any other mentioned embodiments, the CTA can comprise a crystallinity of at least 1, at least 2, at least 5, at least 10, at least 15, at least 20, at least 25, percent as measured according to ASTM F2625. Additionally or alternatively, In one embodiment or in combination with any other mentioned embodiments, the CTA can comprise a crystallinity of not more than not more than 25, not more than 20, not more than 15, not more than 10, not more than 9, not more than 8, not more than 7, not more than 6, not more than 5, not more than 4, not more than 3, not more than 2, or not more than 1 percent as measured according to ASTM F2625. In certain embodiments, the CTA can comprise a crystallinity of 1 to 25 percent as measured according to ASTM F2625.

In one embodiment or in combination with any other mentioned embodiments, the CTA can exhibit a glass transition temperature (“Tg”) of at least 120, at least 125, at least 130, at least 135, at least 140, at least 145, at least 150, at least 155, at least 160, at least 165, at least 170, at least 175, at least 180, or at least 185° C., and/or not more than 250, not more than 245, not more than 240, not more than 235, not more than 230, not more than 225, not more than 220, not more than 215, not more than 210, not more than 205, not more than 200, not more than 195, not more than 190, or not more than 185° C. To determine the Tg of the CTA, the sample is dried to a moisture level below 10 weight percent.

The CTA can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444.

One method of producing cellulose triacetate involves esterification of the cellulose by mixing cellulose with the appropriate organic acids, acid anhydrides, and catalysts. Cellulose is then converted to a cellulose triester which can then be filtered to remove any gel particles or fibers. Water is then added to the mixture to precipitate the CTA. The CTA can then be washed with water to remove reaction by-products followed by dewatering and drying.

Cellulose, the starting material for producing CTA, can be obtained in different grades and sources such as from cotton linters, softwood pulp, hardwood pulp, corn fiber, and other agricultural sources, and bacterial cellulose, among others. The starting material used to produce the CTA may affect the resulting hemicellulose content in the resulting CTA.

In one embodiment or in combination with any other mentioned embodiments, the CTA can comprise a hemicellulose content of at least 0.5, at least 1, at least 2, at least 3, at least 4, at least 5, at least 6, or at least 7 weight percent. Additionally or alternatively, In one embodiment or in combination with any other mentioned embodiments, the CTA can comprise a hemicellulose content of not more than 10, not more than 9, not more than 8, not more than 7, not more than 6, not more than 5, not more than 4, not more than 3, not more than 2, or not more than 1 weight percent.

The dissolution solvent added to the dope mixer 10 can include one or more solvents capable of dissolving a cellulose ester, particularly cellulose triacetate. The dissolution solvent should be added in sufficient quantities so as to effectively dissolve the CTA, thereby forming the CTA dope. In one embodiment or in combination with any other mentioned embodiments, the CTA dope can comprise at least 25, at least 50, at least 55, at least 60, at least 65, at least 70, at least 75, at least 80, at least 85, at least 90, at least 95, or at least 99 weight percent of one or more dissolution solvents, based on the total weight of the dope.

In one embodiment or in combination with any other mentioned embodiments, the dissolution solvent can comprise at least one alkyl amide compound. Amides are functional groups in which a carbonyl carbon atom is linked by a single bond to a nitrogen atom and either a hydrogen or a carbon atom. An amide is an organic compound with the general formula RC(═O)NR′R″. An alkyl amide substitutes hydrogen or an alkyl group or groups in place of at least one of the R, R′, and R″ groups.

In yet other embodiments, the dissolution solvent can comprise dimethylacetamide, dimethylformamide, formamide, N-formylmorpholine, N-methyl-2-pyrrolidone, N-methylformamide, 2-pyrrolidone, tetramethylurea, N-vinylacetamide, or N-vinylpyrrolidone, or combinations thereof. In certain embodiments, the dissolution solvent can comprise dimethylacetamide, dimethylformamide, or combinations thereof.

In one embodiment or in combination with any other mentioned embodiments, the CTA dope is DCM-free and may contain trace amounts of, or alternatively, substantially no amount of dichloromethane, acetone, an ionic liquid, N-methylmorpholine N-oxide (NMMO), a tertiary amine oxide, a metal oxide precursor, acetic acid, a dihydric alcohol, or a combination thereof. In certain embodiments, the CTA dope may contain less than 10, less than 9, less than 8, less than 7, less than 6, less than 5, less than 4, less than 3, less than 2, less than 1, less than 0.5, less than 0.1, less than 0.05, or less than 0.01 weight percent of dichloromethane, acetone, an ionic liquid, N-methylmorpholine N-oxide (NMMO), a tertiary amine oxide, a metal oxide precursor, acetic acid, a dihydric alcohol, or a combination thereof, based on the total weight of the CTA dope.

Due to the type of cellulose ester and dissolution solvents that are used, the CTA dope may exhibit desirable operating viscosities. In one embodiment or in combination with any other mentioned embodiments, the CTA dope may exhibit a viscosity of at least 10, at least 20, at least 30, at least 40, at least 50, at least 60, at least 70, at least 80, at least 90, or at least 100 and/or not more than 5,000, not more than 4,000, not more than 3,000, not more than 2,000, not more than 1,500, not more than 1,000, not more than 950, not more than 900, not more than 850, not more than 800, not more than 750, not more than 700, not more than 650, not more than 600, not more than 550, or not more than 500 poise at the spinning temperature utilized. Alternatively, the viscosity of the spinning dope can have any of these values when a sample of the dope composition used for spinning is taken and when measured at 100° C., or 110° C. It should be noted that this “when measured” standard does not require the CTA dope to be utilized only at this designated temperature; rather, this temperature standard simply provides a temperature threshold at which to measure the viscosity of the CTA dope. Thus, the “when measured” threshold does not in any manner reflect the use or practice of the actual CTA dope. The viscosity defined herein is the “zero” shear viscosity obtained by extrapolating to a very low shear rate when viscosity is plotted versus shear rate, or alternately by using a Brookfield viscometer at low spindle RPM. Desirably, the CTA dope has a viscosity of not more than 1,000, or not more than 950, not more than 900, not more than 850, not more than 800, not more than 750, not more than 700, not more than 650, not more than 600, not more than 550, or not more than 500 poise at the spinning temperature utilized or when measured at 100° C. or at 110° C.

In one embodiment or in combination with any other mentioned embodiments, the CTA dope may comprise some or no additives in addition to the CTA. Such additives can include, but are not limited to, plasticizers, antioxidants, thermal stabilizers, pro-oxidants, acid scavengers, inorganics, pigments, colorants, delustrants, or combinations thereof.

Turning back to FIG. 1, after forming the CTA dope in the dope mixer 10, the newly formed CTA dope may be routed to an optional dope holding tank 20 for temporary storage and/or degassing. The dope holding tank 20 can comprise any conventional storage tank known in the art that is capable of storing the CTA dope. While stored in the holding tank 20, the CTA dope may be subjected to conditions facilitated to maintain the physical characteristics of the dope and/or remove gas bubbles introduced during the mixing step. For example, storing the dope at cold temperatures for too long will lead to unacceptable gelation that will adversely affect spinnability. This is particularly true as dope solids level is increased to higher levels. Thus, the temperature and pressure of the holding and/or degassing tank 20 may be optimized as necessary to enhance and maintain the quality of the CTA dope.

Next, as shown in FIG. 1, the CTA dope can be pumped out of the dope holding tank 20, via a pump 30, into a filter 40, which may remove any large and undesirable particulates and gels from the CTA dope prior to spinning. The filter can comprise any conventional filter apparatus and filter type known in the art.

After the dissolving step, in the wet spinning step the filtered CTA dope may be pumped to the spinneret 51 which is positioned with at least the spinneret face submerged in the DCM-free coagulation bath 50. In one embodiment or in combination with any other mentioned embodiments, the temperature of the filtered CTA dope may be maintained at least 20, at least 25, at least 30, at least 35, at least 40, at least 45, at least 50, at least 55, at least 60, at least 65, at least 70, at least 75, or at least 80° C. and/or not more than 120, not more than 110, or not more than 100° C. In certain embodiments, the face of the spinneret 51 may be maintained at a temperature in the range of 20 to 120° C., 20 to 100° C., 20 to 80° C., 20 to 60° C., or 20 to 40° C.

As shown in FIG. 1, the filtered CTA dope is metered through the spinneret 51 to thereby forming one or more (determined by the number of holes in the face of the spinneret) CTA fibers 52 that coagulate in the DCM-free coagulation bath 50. Furthermore, the resulting one or more CTA fibers 52 are subjected to a jet draw stretch as the coagulation is taking place in the DCM-free coagulation bath 50. As shown in FIG. 1, the process for forming the CTA fibers 52 is a wet spinning process. A wet spinning process is a process which spins one or more CTA fibers 52 by metering the dope through a spinneret 51 with one or more holes in the face of the spinneret 51, wherein the spinneret face is submerged in the DCM-free coagulation bath 50. The shape and size of the hole or holes in the spinneret 51 help determine the size and cross section of the one or more CTA fibers 52. The number of holes in the spinneret face determines the number of fibers 52 simultaneously formed as dope is metered through the spinneret 51. As the dope passes through the holes in the spinneret face, it enters the liquid of the DCM-free coagulation bath 50 in the form of one or more individual fibers.

More particularly, in various embodiments, the filtered CTA dope can be spun at a rate of about 1 to 500 m/min through spinneret holes having a hole area equivalent to a circular diameter of 20 to 200 microns. In one embodiment or in combination with any other mentioned embodiments, the spinneret 51 may be maintained at a temperature of at least 20, at least 25, at least 30, at least 35, at least 40, at least 45, at least 50, at least 55, at least 60, at least 65, at least 70, at least 75, or at least 80° C. and/or not more than 200, not more than 180, not more than 160, not more than 140, not more than 120, not more than 110, or not more than 100° C. In certain embodiments, the face of the spinneret 51 may be maintained at a temperature in the range of 20 to 200° C., 20 to 120° C., 20 to 80° C., 20 to 60° C., or 20 to 40° C.

In one embodiment or in combination with any other mentioned embodiments, based on the low DP and/or low molecular weight of the CTA forming the CTA dope, the CTA dope may exhibit a viscosity, prior to or as fed into the spinneret 51, of at least 10, at least 20, at least 30, at least 40, at least 50, at least 60, at least 70, at least 80, at least 90, or at least 100 and/or not more than 5,000, not more than 4,000, not more than 3,000, not more than 2,000, not more than 1,500, not more than 1,000, not more than 950, not more than 900, not more than 850, not more than 800, not more than 750, not more than 700, not more than 650, not more than 600, not more than 550, or not more than 500 poise at spinning temperature. This spinning temperature is nominally the temperature of the dope as it passes through and into the spinneret. As noted above, the viscosity defined herein is the “zero” shear viscosity obtained by extrapolating to a very low shear rate when viscosity is plotted versus shear rate, or alternately by using a Brookfield viscometer at low spindle RPM.

At the spinneret 51, the filtered CTA dope can be extruded through one or more holes to form one or more CTA fibers 52. At the spinneret 51 and within the DCM-free coagulation bath 50, one or more CTA fibers 52 may be gathered together to form a bundle or a band or a yarn of several hundred, or even thousands of individual fibers 52 within the DCM-free coagulation bath 50. These bundles or bands or yarns may include at least 1, at least 10, at least 50, at least 100, at least 150, at least 200, at least 250, at least 300, at least 350, or at least 400 and/or not more than 10,000, not more than 5,000, not more than 1,000, not more than 900, not more than 800, not more than 700, or not more than 600 fibers. The spinneret 51 may be operated at any speed suitable to produce the one or more CTA fibers 52, which are then assembled into bundles or bands or yarns having desired size and shape. As used herein, the term “individual filament fiber” refers to a continuous fiber that is initially produced by the spinneret 51.

In one embodiment or in combination with any other mentioned embodiments, the one or more CTA fibers 52 are jet draw stretched in the DCM-free coagulation bath 50 at a jet draw stretching ratio (JDSR) of from 0.3 to 1.4 (inclusive). More particularly, in one embodiment or in combination with any other mentioned embodiments, the one or more CTA fibers may be stretched at a JDSR of at least 0.3 and/or not more than 1.4, or not more than 1.3, or not more than 1.2, or not more than 1.1, or not more than 1.0, or not more than 0.9, or not more than 0.8, or not more than 0.7, or not more than 0.6, or not more than 0.5, or not more than 0.4. In addition or in the alternative, the JDSR can be at least 0.3, or at least 0.4, or at least 0.5, or at least 0.6, or at least 0.7, or at least 0.8. For example, the one or more CTA fibers may be stretched at a JDSR in the range of 0.3 to 1.4, or 0.3 to 1.3, or 0.3 to 1.2, or 0.3 to 1.1, or 0.3 to 1.0, or 0.3 to 0.9, or 0.3 to 0.8, or 0.3 to 0.7, or 0.3 to 0.6, or 0.3 to 0.5, or 0.3 to 0.4.

The JDSR is a ratio of the velocity (v2) of the surface of the first driven take-up roll 53 that pulls or draws the one or more CTA fibers through the DCM-free coagulation bath 50 divided by the velocity (v1) of the fibers 52 as the fibers exit the holes in the face of the spinneret 51. A JDSR of 0.3 (v₂/v₁=0.3) indicates that the fibers are being drawn from the DCM-free coagulation bath 50 at a velocity which is slower than the velocity of the one or more CTA fibers as they are exiting the spinneret face, thereby allowing the one or more CTA fibers to coagulate in a relaxed state. A JDSR of 1.0 indicates that the one or more CTA fibers are being drawn from the coagulation bath at the same velocity that they are exiting the spinneret face. A JDSR of 1.2 indicates that the one or more CTA fibers are being drawn from the coagulation bath at a velocity which is 20% faster than the velocity of the one or more CTA fibers as they are exiting the spinneret face, thus stretching the one or more CTA fibers as they coagulate. The velocity of the CTA dope as it leaves the face of the spinneret (v₁) is calculated by dividing the volumetric flow rate of the filtered CTA dope metered to the spinneret per minute by the number of holes in the face of the spinneret then dividing that volumetric flow per hole value by the cross sectional area of the individual hole in the face of the spinneret to determine velocity of the one or more CTA fibers as they exit the spinneret face. The velocity of the surface of the take-up roll 53 (v₂) is calculated by multiplying the circumference of the take-up roll 53 by the revolutions per minute of the roll to arrive at a velocity.

As noted above, jet draw stretching occurs in the DCM-free coagulation bath 50. Thus, in such embodiments, any stretching of the one or more CTA fibers after the first driven take up roll 53 is not jet draw stretching. Stretching that occurs after the first driven take up roll 53, whether the one or more CTA fibers are submerged in liquid or stretched in air, is post jet draw stretching. The post jet draw stretching ratio (PJDSR) for any post jet draw stretching process step is calculated by the velocity of the one or more fibers exiting the process step (Vout) divided by the velocity of the one or more CTA fibers entering the step (Vin). In such embodiments, the one or more CTA fibers may experience no post jet draw stretching steps, or one post jet draw stretching step, or more than one post jet draw stretching steps. Any stretching of the one or more CTA fibers after the first driven take up roll 53 is a separate operation from jet draw stretching which takes place in the DCM-free coagulation bath 50 before the crystalline structure of the polymeric fiber has fully developed.

The DCM-free coagulation bath 50 contains either:

Water and a dope solvent, or water, dope solvent, and a coagulation solvent other than the dope solvent.

If a coagulation solvent is employed, it may be an aqueous coagulation solvent containing water. Water is considered to be an anti-solvent or a coagulant. The total amount of water from all sources contained in the coagulation bath 50 may be at least 1, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, or at least 99 weight percent of water, based on the total weight of all liquids in the coagulation bath 50. Additionally or alternatively, in one embodiment or in combination with any other mentioned embodiments, the amount of water in the coagulation bath 50 may be no more than 99, no more than 90, no more than 80, no more than 70, no more than 60, no more than 50, no more than 40, no more than 30, or no more than 20 weight percent of water, based on the total weight of liquids in the coagulation bath. In certain embodiments, the coagulation bath 50 can contain 10 to 99, 20 to 80, 25 to 70, or 30 to 60 weight percent water, based on the total weight of the liquids in the coagulation bath 50. The total amount of dope solvent in the coagulation bath 50 can be at least 0.1, at least 0.5, at least 1.0 at least 2.0 or at least 3.0 percent by weight based on the weight of all liquids in the coagulation bath. Additionally or in the alternative, the total amount of dope solvent in the coagulation bath 50 can be not more than 80, not more than 75, not more than 70, not more than 65, not more than 60, not more than 55, or not more than 50 percent by weight based on the weight of all liquids in the coagulation bath 50. Suitable ranges of dope solvent in the coagulation bath 50 include 0.1 to 80, or 0.5 to 80, or 1 to 80, or 0.1 to 75, or 0.5 to 75, or 1 to 75, or 0.1 to 70, or 0.5 to 70, or 1 to 70, or 0.1 to 65, or 0.5 to 65, or 1 to 65, or 0.1 to 60, or 0.5 to 60, or 1 to 60, or 0.1 to 55, or 0.5 to 55, or 1 to 55, or 0.1 to 50, or 0.5 to 50, or 1 to 50 weight percent based on the weight of all liquids in the coagulation bath 50. The dope solvent in the coagulation bath 50 can be obtained as fresh dope solvent added to the coagulation bath or obtained from washing or exuding residual dope solvent off the fiber as it is drawn through the coagulation bath 50, or both. The dope solvent can be at least one of the same solvents used in the dope composition to dissolve the CTA polymer before spinning. In one embodiment or in combination with any other mentioned embodiments, the coagulation bath 50 contains dope solvent solely obtained from residual dope solvent on or in the fiber. In one embodiment or in combination with any other mentioned embodiments, the dope solvent in the coagulation bath 50 is obtained both from the residual dope solvent in or on the fiber and with addition of fresh make-up dope solvent to the coagulation bath 50.

The total amount of coagulation solvent (not including any amount of water regardless of its source) in the DCM-free coagulation bath 50 can be at least 1, at least 5, at least 10, at least 15, or at least 20 weight percent of the additional solvent, based on the total weight of the liquids in the coagulation bath 50. Additionally or alternatively, in one embodiment or in combination with any other mentioned embodiments, the coagulation solvent can comprise not more than 90, not more than 80, not more than 70, not more than 65, not more than 60, not more than 50, not more than 40, not more than 30, not more than 20, not more than 10, not more than 5, or not more than 1 weight percent of the additional solvent, based on the total weight of the liquids in the DCM-free coagulation bath 50. The amount of coagulation solvent in the DCM-free coagulation bath 50 can range of 1 to 90, 5 to 80, 10 to 70, 20 to 65, 5 to 65, or 10 to 60 weight percent of at least one additional solvent, based on the total weight of the liquids in the DCM-coagulation bath 50.

Suitable coagulation solvents include at least one alkyl amide compound. Examples of suitable alkyl amide compound solvents include dimethylacetamide, dimethylformamide, formamide, N-formylmorpholine, N-methyl-2-pyrrolidone, N-methylformamide, 2-pyrrolidone, tetramethylurea, N-vinylacetamide, or N-vinylpyrrolidone, or combinations thereof. In one embodiment or in combination with any other mentioned embodiments, the coagulation solvent includes dimethylacetamide, dimethylformamide, or combinations thereof.

In one embodiment or in combination with any other mentioned embodiments, DCM is not added to the DCM-free coagulation bath 50, or the DCM-free coagulation bath 50 does not contain any DCM, or the DCM-free coagulation bath 50 contains only trace amounts (e.g. less than 1 wt. %, or less than 5,000 ppm, or less than 1,000 ppm, or less than 500 ppm, or less than 100 ppm, of DCM). Trace amounts can possibly be contained in the DCM-free coagulation bath 50 even though the added coagulation solvent does not contain any DCM due to inadequate washing and cleaning of the dope tank or the DCM-free coagulation bath 50 contained DCM in prior runs.

In one embodiment or in combination with any other mentioned embodiments, DCM and one or more of the additional solvents is not added to the DCM-free coagulation bath 50, or the DCM-free coagulation bath does not contain any DCM or any of at least one or more of the additional solvents, or the DCM-free coagulation bath 50 contains only trace amounts (e.g. less than 1 wt. %, or less than 5,000 ppm, or less than 1,000 ppm, or less than 500 ppm, or less than 100 ppm) or DCM and one or more of the additional solvents. Such additional solvents include acetone, an ionic liquid, N-methylmorpholine N-oxide (NMMO), a tertiary amine oxide, a metal oxide precursor, acetic acid, a dihydric alcohol, or a combination thereof.

In one embodiment or in combination with any other mentioned embodiments, the DCM-free coagulation bath 50 may contain less than 10, less than 9, less than 8, less than 7, less than 6, less than 5, less than 4, less than 3, less than 2, less than 1, less than 0.5, less than 0.1, less than 0.05, or less than 0.01 weight percent of any one of DCM, acetone, an ionic liquid, N-methylmorpholine N-oxide (NMMO), a tertiary amine oxide, a metal oxide precursor, acetic acid, a dihydric alcohol, or the coagulation bath 50 contains less than the combined amount of all of these solvents, based on the total weight of the liquids in the DCM-free coagulation bath 50.

Additionally or alternatively, in one embodiment or in combination with any other mentioned embodiments, the DCM-free coagulation bath 50, including the coagulation solvent therein, may be maintained at a temperature of at least 20° C., or at least 25° C. and/or not more than 40° C., not more than 35° C. In certain embodiments, the first coagulation bath 50, including the coagulation solvent therein, may be maintained at a temperature ranging from 20 to 40° C., 20 to 35° C., 20 to 30° C., 25 to 40° C., 30 to 40° C., 35 to 40° C., or 25 to 35° C.

Although FIG. 1 depicts a specific wet spinning technique, it is envisioned that downstream process steps (after the take up roll 53) may be arranged in a variety of alternative sequences. For example, the downstream steps of the process, which may include one or more additional coagulating steps, one or more washing steps, one or more post jet draw stretching steps, one or more fiber finish application steps, one or more drying steps, one or more thermal treatment steps, a crimping step, a cutting step, a winding step, a packaging step or a combination thereof may be arranged in various sequences.

Desirably, the one or more CTA fibers 52 formed in the DCM-free coagulation bath 50 are monocomponent fibers, meaning they have a single continuous phase. Monocomponent fibers can comprise only one material (e.g., the CTA) or a uniformly blended composition. Monocomponent fibers are distinguishable from and not considered “bicomponent” or “multicomponent fibers” which are characterized by internal phases or boundaries delineating regions of different compositions within the external surface of the fiber. In one embodiment or in combination with any other mentioned embodiments, the fibers in or emerging from the first coagulation bath, or the final finished fibers, are monocomponent and comprise at least 50, at least 55, at least 60, at least 65, at least 70, at least 75, at least 80, at least 85, at least 90, at least 95, at least 99, or at least 99.9, or 100 weight percent of a single type of polymer, such as CTA, based on the total weight of the fiber and excluding the weight of any finish or cutting lubricants.

The one or more CTA fibers 52 discharged from the spinneret 51, may have any suitable transverse cross-sectional shape. Exemplary cross-sectional shapes include, but are not limited to, round, kidney bean, ribbon, crenulated, multi-lobal, or other than round (non-round). It is well known in the art that the shape of the cross-section is typically determined by the balance of coagulation diffusion into the fiber relative to the rate of diffusion of solvent out of the fiber in the coagulation bath. When these are balanced, the fiber remains more nearly circular. Adjusting bath temperature and/or solvent level, for example, can be used to make fiber more or less circular in shape, or alternately a kidney bean or ribbon/lobed type shape.

In one embodiment or in combination with any other mentioned embodiments, the one or more fibers 52 discharged from the spinneret 51 may have a substantially round cross-sectional shape. As used herein, the term “cross-section” generally refers to the transverse cross-section of the fiber measured in a direction perpendicular to the direction of elongation of the fiber. The cross-sectional area and perimeter of the fiber may be determined and measured using Quantitative Image Analysis (“QIA”).

The cross-sectional shape of an individual fiber may also be characterized according to its deviation from a round cross-sectional shape. In some cases, this deviation can be characterized by the shape factor of the fiber, which is determined by the following formula:

$$Shape Factor = \frac{Perimeter}{\sqrt{( 4 π * CrossSectional Area )}}$$

In some embodiments, the shape factor of the one or more CTA fibers can be from 1 to 2, 1 to 1.8, 1 to 1.7, 1 to 1.5, 1 to 1.4, 1 to 1.25, 1 to 1.15, or 1 to 1.1. The shape factor of a fiber having a perfect round cross-sectional shape is 1. The shape factor can be calculated from the cross-sectional area and perimeter of the fiber, both of which can be measured using QIA.

Furthermore, in certain embodiments, the one or more CTA fibers 52 may be in the form of solid fibers (fibers having a solid cross-sectional shape without an aperture present therein) and not in the form of hollow fibers.

As discussed above, the silk factor property helps determine the suitability of the CTA fiber(s) produced by this process in downstream applications. Tenacity is a critical fiber property that measures how much tensile force can be applied to the fiber before it breaks. A fiber with a lower tenacity can be pulled apart by applying less force than would be required to break a fiber with a higher tenacity. For the purposes of textile manufacturing, a tenacity of less than 1.5 g/denier can be problematic because the fiber may break under regular operating conditions. In one embodiment or in combination with any other mentioned embodiments, the CTA fiber(s) produced by this process may exhibit a tenacity of at least 1.5, or greater than 1.5, or at least 1.52, or at least 1.55, or at least 1.58, or at least 1.6, or at least 1.7, or at least 1.8, or at least 1.9, or at least 2.0, or at least 2.1, or at least 2.2, or at least 2.3, or at least 2.4, or at least 2.5 g/denier as measured according to ASTM D22556.

Elongation, also known as elongation at break, is expressed as a percentage and it is indicative of how much a yarn or fiber will stretch before it breaks. In one embodiment or in combination with any other mentioned embodiments, the CTA fiber(s) produced by this process may exhibit an elongation at break of at least 15, or at least 16, or at least 17, or at least 18, or at least 19, or at least 20, or at least 21, or at least 22, or at least 23, or at least 24, or at least 25, or at least 26, or at least 27, or at least 28, or at least 29, or at least 30 percent as measured according to ASTM D22556.

Silk factor (“SF”) is an empirically determined relationship between tenacity and elongation that is used to predict the failure envelope of a given fiber. Silk Factor can be used to characterize a yarn or fiber's suitability for use in a given process and is calculated based on the following formula:

$$Silk Factor = Tenacity * \sqrt{Elongation}$$

In one embodiment or in combination with any other mentioned embodiments, the CTA fiber(s) produced by this process may exhibit a silk factor of at least 5.0, or at least 6.0, or at least 7.0, or at least 7.5, or at least 8.0, or at least 8.5 or at least 9.0 iwhere elongation is expressed in percent and tenacity is expressed in grams/denier.

As noted above, the CTA fiber(s) produced by this process are formed as continuous fibers. In one embodiment or in combination with any other mentioned embodiments, the fiber(s) produced by the process may be continuous fiber(s) or they may be cut to form staple fibers.

As shown in FIG. 1, the one or more CTA fibers 52 may be wrapped around take-up roll 53 which provides tension and pulls the fibers out of the DCM-free coagulation bath 50 guiding the fibers to downstream steps of the process, which may include, for example, one or more additional coagulating steps, one or more washing steps, one or more post jet draw stretching steps, one or more fiber finish application steps, one or more drying steps, one or more thermal treatment steps, a crimping step, a cutting step, a winding step, a packaging step or a combination thereof which may be arranged in various sequences.

Turning back to FIG. 1, the CTA fibers 52 formed in the first coagulation bath 50 may be gathered into a band, bundle, or yarn 54. The band, bundle, or yarn 54 may comprise a plurality of the one or more CTA fibers 52. Each of these bands, bundles, yarns may include at least 1, at least 10, at least 50, at least 100, at least 150, at least 200, at least 250, at least 300, at least 350, or at least 400 and/or not more than 10,000, not more than 5,000, not more than 1,000, not more than 900, not more than 800, not more than 700, or not more than 600 individual fibers.

After the wet spinning step, as shown in FIG. 1, the band, bundle, or yarn 54 may be subjected to one or more post jet draw stretching steps 60 in order to be subjected to post jet draw stretching (PJDS). This PJDS is differentiated from JDS in that stretching occurs after the driven take up roll 53 (which marks the end of the wet spinning step) thus the fiber has already undergone some coagulation and crystallization. Because post jet draw stretching of the fiber is applied after the material is already partially solidified, it tends to cause more microscale damage to the fiber(s) if done excessively. Hence, post jet draw stretching may boost tenacity, but usually also causes a large decrease in elongation.

While in a post jet draw step 60, the band 54 may be subjected to additional stretching so as to further modify the length and width of the yarn and modify the polymer orientation within the individual fibers. The PJDS step or steps may stretch the band 54 in ambient temperature air, in heated air, in ambient temperature water, in heated water, in an aqueous solvent at ambient temperature, in a heated aqueous solvent, in steam or in any combination thereof. The post jet draw stretching step or steps may involve passing the band 54 through driven or speed-controlled draw rolls or pairs of draw rolls, which may have heat applied to improve the ductility of the fibers. Elevating the temperature of the band 54 may also be accomplished by passing the band 54 through a hot water bath or a steam box or stream of hot air in order to sufficiently soften the fibers for drawing. Generally, the velocity of each successive draw roll or pair of draw rolls (Vout) is greater than the velocity of the preceding draw roll or pair of draw rolls (Vin) so that the band 54 is subjected to stretching, which may impart additional crystallinity and reduced denier per filament as the band 54 is substantially stretched. The total post jet draw stretching ratio is calculated by multiplying the PJDS ratios of all of the one or more post jet draw stretching steps comprised by the process. For example, if a process was configured with three post jet draw stretching steps which applied PJDS ratios of 1.10, 1.25, and 1.33 respectively, the total post jet draw stretching ratio would be (1.10×1.25×1.33) or 1.83. In one embodiment or in combinations with any other mentioned embodiments, post jet draw stretching and post jet draw stretching steps can be combined with washing steps, fiber finish application steps, drying steps, and/or thermal treatment steps.

Before or after a post jet draw stretching step 60, the band 54 may be introduced into one or more additional coagulation baths 70 and/or one or more washing steps 80. These additional coagulation baths typically contain the same solvents and operating conditions as the first coagulation bath 50, but usually involve a lower solvent level than the first coagulation bath 50. Alternatively, it is possible to exclude the additional coagulation baths in certain embodiments or optionally replace such additional baths with one or more washing steps.

The washing step 80 may comprise guiding the band 54 through a bath comprising water at various temperatures to facilitate the removal of residual solvent from the band 54. Washing steps may also include the use of water sprayed onto the band 54. Wash temperatures typically range from about room temperature up to 99° C., although it has been observed that higher wash temperatures tend to alter the properties of the fiber(s) produced by the process. Thus, it may be desirable to utilize a wash temperature of less than 90° C., or less than 75° C., or more desirably less than 50° C.

In one embodiment or in combination with any other mentioned embodiments, after exiting the final washing step 80, the washed band 54 may then be subjected to a fiber finish application step.

After any washing steps and finish application steps, the band 54 may then be subjected to one or more drying steps 90. The one or more drying steps 90 may comprise any conventional drying apparatus known in the art including but not limited to heated air drying (unrestrained or partially restrained), infrared drying, heated godet roll drying, and thru-air perforated drum drying. Generally, as the band 54 dries, the fiber(s) making up said will contract or shrink both axially and longitudinally. In the one or more drying steps, the band 54 is not restrained in such a manner that prevents all longitudinal shrinkage. The fibers of the band 54 may be dried unrestrained, and are completely shrunk in the longitudinal direction by allowing the band 54 to be deposited on a moving dryer conveyor wherein no tension is applied to the shrinking fibers of the band. Alternatively, the fibers of the band 54 may be dried partially restrained, wherein they are partially shrunk or completely shrunk depending on the tension applied to the band as it is dried. The amount of tension applied to the band 54 as it dries may be controlled by varying the exit velocity of the band 54 leaving the drying step relative to the entrance velocity of the band 54 as it enters the drying step. If the entrance and exit velocities are equal, then the band 54 is considered fully restrained where zero longitudinal shrinkage can occur as the fibers of the band 54 are dried. When the exit velocity of the band 54 is less than the entrance velocity, the band 54 is being shrunk as it is being dried. When the exit velocity of the band 54 cannot be decreased without slack forming in the band 54 as it dries, the band 54 is being completely shrunk. Any exit velocity less than the entrance velocity but greater than the complete shrinkage velocity enables the band 54 to be partially shrunk.

In one embodiment or in combination with any other mentioned embodiments, before or after the one or more drying steps 90, the band 54 may be subjected to one or more thermal treatment steps 100. The one or more thermal treatment steps 100 may comprise any conventional annealing apparatus, autoclaving apparatus, or combinations thereof known in the art. Generally, the thermal treatment process step comprises: (i) heating the fiber(s) or band up to a temperature greater than half of its melting point, (ii) holding the fiber(s) or band at that temperature for a period of time, and (iii) subsequently cooling the fiber(s) or band in a manner that reduces internal stress within the fiber(s). In the one or more thermal treatment steps, the band 54 may not be restrained in such a manner that prevents all longitudinal shrinkage. The fiber(s) or band may be thermally treated unrestrained, wherein they are allowed to freely shrink in the longitudinal direction by allowing the band 54 to be deposited on a moving conveyor wherein no tension is applied to the band 54 as it is thermally treated. Alternatively, the fiber(s) of the band 54 may be thermally treated partially restrained, wherein they are allowed to shrink partially or shrink completely depending on the tension applied to the band 54 in the thermal treatment step. This tension may be controlled as in the drying step by varying the velocities of the band 54 at the entrance and exit of the thermal treatment step. The one or more thermal treatment steps 100 may take place after the optional crimping step 110 or before it. In configurations where the thermal treatment follows the crimping, it is believed that the thermal treatment step helps to set the crimp pattern into the fiber. The one or more thermal treatment steps 100 may comprise heated air or steam and may be carried out at atmospheric pressure, greater than atmospheric pressure, or under vacuum. In some configurations, one of the thermal treatment steps may be carried out on finished packages of CTA fiber.

In another embodiment of the invention, the thermal treatment step 100 may be conducted at a temperature that is at least 20 degrees less than the Tg of the CTA fiber, at least 15 degrees less than the Tg of the CTA fiber, and less than 10 degrees less than the Tg of the CTA fiber.

In one embodiment or in combination with any other mentioned embodiments, the continuous fiber(s) of band 54 may be accumulated onto bobbins, cores or tubes in the packaging step 130. The packaging step 130 may comprise any conventional winding and packaging apparatus known in the art.

In one embodiment or in combination with any other mentioned embodiments, the band 54 may be subjected to a crimping step which at least partially crimps the CTA fiber(s). In one embodiment or in combination with any other mentioned embodiments, the CTA fiber and/or the band 54 may be crimped. Alternatively, in certain embodiments, the CTA fiber and/or the band 54 is not crimped.

The CTA fiber(s) and/or the band 54 may be passed through a crimping zone wherein a patterned wavelike shape may be imparted to at least a portion, or substantially all, of the individual fibers. When used, the crimping zone includes at least one crimping device for mechanically crimping the CTA fiber(s). Generally, the CTA fiber(s) desirably are not crimped by thermal or chemical means (e.g., hot water baths, steam, air jets, or chemical coatings), but instead are mechanically crimped using a suitable crimper. One example of a suitable type of mechanical crimper is a “stuffing box” or “stuffer box” crimper that utilizes a plurality of rollers to generate friction, which causes the CTA fiber(s) to buckle and form crimps. Other types of crimpers may also be suitable. Examples of equipment suitable for imparting crimp fibers are described in, for example, U.S. Pat. Nos. 9,179,709; 2,346,258; 3,353,239; 3,571,870; 3,813,740; 4,004,330; 4,095,318; 5,025,538; 7,152,288; and 7,585,442, each of which is incorporated herein by reference to the extent not inconsistent with the present disclosure.

In one embodiment or in combination with any other mentioned embodiments, crimping may be performed such that the CTA fiber(s) have a crimp frequency of at least 5, at least 7, at least 10, at least 12, at least 13, at least 15, or at least 17 and/or not more than 30, not more than 27, not more than 25, not more than 23, not more than 20, or not more than 19 crimps per inch (“CPI”), as measured according to ASTM D3937-12. In certain embodiments, the average CPI of the CTA fiber(s) that make up the band 54 and/or various downstream products may be in the range of 7 to 30 CPI, 10 to 30 CPI, 10 to 27 CPI, 10 to 25 CPI, 10 to 23 CPI, 10 to 20 CPI, 12 to 30 CPI, 12 to 27 CPI, 12 to 25 CPI, 12 to 23 CPI, 12 to CPI, 15 to 30, CPI, 15 to 27 CPI, 15 to 23 CPI, 15 to 20 CPI, or 15 to 19 CPI.

In one embodiment or in combination with any other mentioned embodiments, when crimped, the crimp amplitude of the CTA fiber(s) may vary and can, for example, be at least 0.85, at least 0.90, at least 0.93, at least 0.96, at least 0.98, at least 1.00, or at least 1.04 mm. Additionally or alternatively, In one embodiment or in combination with any other mentioned embodiments, the crimp amplitude of the CTA fiber(s) can be up to 1.75, up to 1.70, up to 1.65, up to 1.55, up to 1.35, up to 1.28, up to 1.24, up to 1.15, up to 1.10, up to 1.03, or up to 0.98 mm.

Additionally, in one embodiment or in combination with any other mentioned embodiments, the CTA fiber(s) that make up band 54 and/or staple fibers produced therefrom may have a crimp ratio of at least 1:1. As used herein, “crimp ratio” refers to the ratio of the non-crimped band or fiber length to the crimped band or fiber length. In certain embodiments, the CTA fiber(s) and/or staple fibers produced therefrom may have a crimp ratio of at least 1:1, at least 1.1:1, at least 1.125:1, at least 1.15:1, or at least 1.2:1.

Crimp amplitude and crimp ratio are measured according to the procedure outlined in U.S. Pat. App. Pub. No. 2020/0299822, which is incorporated herein by reference to the extent not inconsistent with the present disclosure.

Additionally, or alternatively, in one embodiment or in combination with any other mentioned embodiments, one or more types of surface finish may be applied to the CTA fiber(s) and/or the band 54 formed therefrom. The method of application is not limited and can include the use of spraying, wick application, dipping, or use of squeeze, lick, or kiss rollers. The location for applying a finish to a fiber or the band 54 can vary depending on the function of the finish. For example, the lubricant finish can be applied after spinning and before crimping, or before gathering the fibers into a band, bundle or yarn. Cutting lubricants and/or antistatic lubricants can be applied before or after crimping and prior to drying. Suitable amounts of all finishes (whether lubricant, cutting lubricant, antistatic electricity finish, or otherwise) on the CTA fibers can be at least 0.01, at least 0.02, at least 0.05, at least 0.10, at least 0.15, at least 0.20, at least 0.25, at least 0.30, at least 0.35, at least 0.40, at least 0.45, at least 0.50, at least 0.55, or at least 0.60 weight percent finish-on-yarn (“FOY”) relative to the weight of the dried CTA fiber(s). Additionally or alternatively, in one embodiment or in combination with any other mentioned embodiments, the cumulative amount of finish may be present in an amount of not more than 2.5, not more than 2.0, not more than 1.5, not more than 1.2, not more than 1.0, not more than 0.9, not more than 0.8, or not more than 0.7 weight percent FOY based on the total weight of the dried fiber. The amount of finish on the fibers as expressed by weight percent may be determined by solvent extraction. As used herein “FOY” or “finish on yarn” refers to the amount of finish on the fiber or yarn less any added water.

In one embodiment or in combination with any other mentioned embodiments, the CTA fiber(s) can include at least one plasticizer or, in the alternative, no plasticizer. For example, the CTA fiber(s) may be at least partially coated with a dry plasticizer. The CTA fiber(s) may comprise less than 15, less than 12, less than 10, less than 9, less than 8, less than 7, less than 6, less than 5, less than 4, less than 3, less than 2, less than 1, less than 0.5, less than 0.1, less than 0.05, less than 0.01, less than 0.005, less than 0.001, or less than 0.0007 weight percent of at least one plasticizer, based on the total weight of the CTA fiber. When present, the plasticizer may be incorporated into the CTA fiber itself by spinning a dope containing a plasticizer, contained in a flake used to make the dope, and/or the plasticizer may be applied to the surface of the fiber by any of the methods used to apply a finish. If desired, the plasticizer can be contained in the finish formulation.

The resulting CTA fibers may be used to produce a vast array of end products, such as tow band, staple fibers, filament yarns, spun yarns, woven articles, nonwoven articles, and/or knitted textiles.

In one embodiment or in combination with any other mentioned embodiments, the CTA fibers and/or the band 54 described above may be cut into staple fibers in cutting step 120. Any suitable type of cutting device may be used that is capable of cutting the fibers to a desired length without excessively damaging the fibers. Examples of cutting devices can include, but are not limited to, rotary cutters, guillotines, stretch breaking devices, reciprocating blades, or combinations thereof. Once cut, the CTA staple fibers may be baled or otherwise bagged or packaged for subsequent transportation, storage, and/or use in packaging step 130. In various embodiments, the d50 length of the staple fibers may be at least 5, at least 10, at least 20, at least 30, at least 40, or at least 50 mm and/or not more than 150, not more than 140, not more than 130, not more than 125, not more than 120, not more than 115, not more than 110, not more than 105, not more than 100, or not more than 95 mm.

Additionally or alternatively, in one embodiment or in combination with any other mentioned embodiments, the denier per filament (weight in g of 9000 m fiber length), or “DPF,” of the CTA fiber(s) (whether CTA staple fibers or CTA continuous fibers) may be within a range of 0.5 to not more than 20, or 0.5 to not more than 15, or 0.5 to not more than 10, or 1 to not more than 8, or 1 to not more than 5, or 2 to not more than 4. The particular method for measurement is not limited and include the ASTM 1577-07 method using the FAVIMAT vibroscope procedure if fibers can be obtained from which the staple fibers are cut, or a microbalance weight measurement of a sample of known length or a width analysis using any convenient optical microscopy or analyzer. The DPF can also be correlated to the maximum width of a fiber.

Additionally or alternatively, In one embodiment or in combination with any other mentioned embodiments, the CTA fiber(s) and/or the CTA staple fibers produced therefrom may comprise an average cross sectional transverse width of at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, or at least 20 microns and/or not more than 300, not more than 200, not more than 150, not more than 100, not more than 90, not more than 80, not more than 70, not more than 60, not more than 50, not more than 40, not more than 30, or not more than 25 microns. In certain embodiments, the individual cellulose ester fibers and/or the staple fibers produced therefrom may comprise an average width in the range of 1 to 300, 2 to 200, 3 to 100, 4 to 70, 5 to 50, or 8 to 30 microns.

In one embodiment or in combination with any other mentioned embodiments, the staple fibers can be formed into a CTA spun yarn. Spun yarns are continuous strands comprising short staple fibers which are mechanically entangled by a staple yarn spinning process. Staple yarn spinning processes can be, but are not limited to, ring spinning, open-end spinning, air jet spinning, compact spinning, siro spinning, vortex spinning, worsted spinning, semi-worsted spinning, woolen spinning, and wet spinning with flax.

In one embodiment or in combination with any other mentioned embodiments, the CTA fibers may be formed into a nonwoven article, such as a nonwoven textile. Exemplary nonwoven articles can include wet-laid nonwoven articles, air-laid non-woven articles, carded articles, and/or dry-laid non-woven articles.

In one embodiment or in combination with any other mentioned embodiments, the CTA yarns may be formed into a woven article, such as a woven textile. Woven textiles can be formed on a loom by interlacing at least two yarns, a warp yarn, and a weft yarn, wherein the warp yarn strands are oriented in parallel and the weft yarns are interlaced at an angle to the orientation of the warp yarns in an alternating pattern over and under the warp yarns.

In one embodiment or in combination with any other mentioned embodiments, the CTA yarns may be formed into a knitted article, such as a knitted textile. Such knitted textiles may be formed by interlocking loops of yarn.

In one embodiment or in combination with any other mentioned embodiments, the end products described herein, including the staple fibers, yarns, nonwoven articles, knitted articles and the woven articles, may comprise at least 0.25, at least 0.5, at least 0.75, at least 1, at least 2, at least 3, at least 4, at least 5, at least 6, at least 7, at least 8, at least 9, at least 10, at least 12, at least 15, at least 18, at least 20, at least 25, at least 30, at least 35, at least 40, at least 45, at least 50, at least 55, at least 60, at least 65, at least 70, at least 75, at least 80, at least 85, at least 90, at least 95, at least 99, or at least 99.9 weight percent of one or more CTA fibers, based on the total weight of the article. Additionally or alternatively, In one embodiment or in combination with any other mentioned embodiments, the end products described herein, including the staple fibers, yarns, nonwoven articles, knitted articles, and the woven articles, may comprise not more than 99, not more than 95, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, not more than 9, not more than 8, not more than 7, not more than 6, or not more than 5 weight percent of one or more CTA fibers, based on the total weight of the article. In certain embodiments, the end products may be formed entirely from the CTA fibers or comprise in the range of 0.25 to 50, 1 to 99, 1 to 50, 50 to 99, 1 to 20, or 0.25 to 5 weight percent of one or more CTA fibers, based on the total weight of the article.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” “comprise,” “contain,” “containing,” and “contains” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

As used herein, the terms “containing,” “contains,” and “contained” have the same open-ended meaning as “comprising,” “comprises,” and “comprise” provided above.

### NUMERICAL RANGES

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

### CLAIMS NOT LIMITED TO DISCLOSED EMBODIMENTS

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

### EXAMPLES

The following examples are intended to be illustrative of the present invention in order to teach one of ordinary skill in the art to make and use the invention and are not intended to limit the scope of the invention in any way. As described below, several tests were performed on samples produced via the process described by the present invention as well as comparative process conditions.

### Example 1

Dope was prepared in a 500 ml three neck flask using cellulose triacetate (CTA) from Eastman Chemical Co., Kingsport TN (Eastman CTA VM 149). CTA was dissolved in dimethylacetamide (DMAc) with the concentrations of CTA ranging from 18 to 24 wt % based on the combined weight of the CTA and DMAc and held at 90° C. for two hours. A stirrer speed of 400 RPM was used for the first 1.5 hours then slowed to 150 RPM for the last 0.5 hour. The resultant spinning dope was cooled down to 60° C. and degassed for 3 hours.

The spinning dope was transferred from the three neck flask to a 50 ml stainless steel syringe with an attached spin pack comprising a multifilament spinneret and one layer of filter media having a nominal pore size of 8 microns. The syringe and spin pack apparatus was connected to a high-pressure syringe pump capable of precisely metering the spinning dope to control the dope flow rate to +/−1%. The spinneret face comprised 19 circular holes, each hole having a diameter measuring 0.045 mm (45 micron). The spinneret was submerged in a coagulant bath containing an aqueous solution of DMAc. The concentration of DMAc in the coagulant bath was varied from 25 to 65 wt % based on the weight of all liquids in the bath. The spinning dope was formed into CTA fibers as it was wet spun through the holes in the submerged spinneret face. The CTA fibers passed through the coagulant bath, guided by non-driven guide rolls to a driven take up roll. The jet draw stretching ratio was controlled by adjusting the surface velocity of the driven take up roll. A take up roll surface velocity less than the calculated velocity of the dope exiting the holes in the spinneret face yields a jet draw stretching ratio less than 1.0, while take up roll surface velocities faster than the calculated exit velocity of the dope yielded jet draw stretching ratios greater than 1.0. From the driven take up roll, the fibers were fed to a winder which wound the fibers onto a bobbin. The post jet draw stretching ratio was calculated by dividing the surface velocity of the driven winder roll by the surface velocity of the driven take up roll. The post jet draw stretching ratio was performed in air at room temperature.

The fibers on the bobbin were washed by immersion in deionized water for 10 minutes in an overflow water bath at room temperature. Following washing, the fiber was cut from the bobbin. These resulting loose fibers were dried in a convection oven for 15 minutes at 120° C.

The mechanical performance of the fibers was evaluated on a FAVIMAT according to ASTM D1577-07 (2018) for denier determinations and ASTM D3822/D3822M-14 (2020) for tenacity and elongation determinations (test conditions: 25 mm gauge length, 15 mm/min strain rate, 0.05 g/denier pre-tension). The silk factor was calculated from the elongation and tenacity results.

As can be seen in Table 1, the mechanical properties of comparative samples 1-10 yielded sub 8.0 silk factors while samples 11 and 12, produced according to the present invention, yielded a silk factors greater than 8.5. Operation of the wet spinning process according to the limitations of the present claims enables a DCM-free process for producing CTA fibers with silk factors greater than 8.0.

TABLE 1
CTA fibers wet spun under various conditions

| | | | | Post | | Bath | | | | | |
|---|---|---|---|---|---|---|---|---|---|---|---|
| | Dope | Dope | Jet | Jet | Bath | Solvent | Break | | | | |
| | Solids | Temp | Draw | Draw | Temp | Conc. | Elong. | Tenacity | Denier | Modulus | Silk |
| Sample | (%) | (° C.) | Ratio | Ratio | (° C.) | (%) | (%) | (g/den) | (g/9000 m) | (gf/den) | Factor |
| 1 | 24 | 100 | 1.00 | 1.20 | 21 | 40 | 12.10 | 2.15 | 3.24 | 67.57 | 7.47 |
| 2 | 22 | 60 | 1.00 | 1.20 | 10 | 65 | 7.80 | 2.07 | 2.82 | 75.71 | 5.78 |
| 3 | 22 | 75 | 1.00 | 1.20 | 45 | 25 | 26.82 | 1.24 | 3.52 | 37.13 | 6.42 |
| 4 | 20 | 60 | 1.00 | 1.05 | 30 | 45 | 22.72 | 1.54 | 2.79 | 47.71 | 7.34 |
| 5 | 20 | 60 | 1.00 | 1.35 | 45 | 45 | 10.95 | 1.39 | 3.02 | 55.77 | 4.60 |
| 6 | 20 | 45 | 1.00 | 1.35 | 15 | 45 | 10.19 | 2.27 | 2.49 | 68.69 | 7.25 |
| 7 | 20 | 60 | 1.00 | 1.35 | 45 | 45 | 11.19 | 1.43 | 2.56 | 55.61 | 4.78 |
| 8 | 18 | 45 | 1.00 | 1.23 | 45 | 65 | 4.66 | 1.15 | 2.17 | 56.76 | 2.48 |
| 9 | 18 | 60 | 1.00 | 1.05 | 30 | 45 | 22.13 | 1.41 | 2.43 | 43.52 | 6.63 |
| 10 | 18 | 60 | 1.00 | 1.20 | 30 | 45 | 15.12 | 1.66 | 2.24 | 54.32 | 6.45 |
| 11 | 20 | 60 | 0.65 | 1.22 | 30 | 25 | 21.61 | 1.83 | 2.89 | 57.64 | 8.51 |
| 12 | 20 | 60 | 1.00 | 1.05 | 30 | 25 | 34.09 | 1.54 | 2.32 | 49.64 | 8.99 |

### Example 2

CTA (Eastman CTA VM 149) from Eastman Chemical Co., Kingsport TN was dissolved in DMAc at a concentration of 20 wt % CTA based on the combined weight of the CTA and DMAc and stirred at 1000C until dope was clear and free of visible swollen particles. The resulting dope was filtered through a 15-micron polyester nonwoven filter media.

CTA fibers were wet spun by extruding the filtered dope at 600C through a spinneret with 500 circular cross section holes. Two spinnerets were used to wet spin CTA fibers, one having holes measuring 0.040 mm (40 micron) in diameter and another one having holes measuring 0.060 mm (60 micron) diameter. The spinneret was submerged in a coagulation bath which contained a coagulation solution of either 60 wt % DMAc and 40 wt % water or 40 wt % DMAc and 60 wt % water based on the total weight of the solution which was controlled at a temperature of 250C. Upon exiting the spinneret, the fibers passed through the coagulation bath, guided by non-driven guide rolls to a driven take up roll.

The extruded fibers were drawn through the coagulation bath by the driven take up roll, whose speed was varied to control the jet draw stretch ratio (JDSR) from 0.4 to 0.7 when using the 40-micron spinneret and 0.7 to 1.1 when using the 60-micron spinneret. The jet draw stretch ratio was controlled by adjusting the surface velocity of the take up roll relative to the calculated velocity of the dope exiting the spinneret.

After the driven take up roll, the fibers were submerged and passed through a 25° C. stretching bath containing either a solution of 50 wt % DMAc/50 wt % water or 30 wt % DMAc/70 wt % water based on the total weight of the bath. A post jet draw stretching ratio (PJDSR) of either 1.0 or 1.16 was applied in the stretching bath.

The fibers were then passed through one washing bath containing 100% water and two pairs of washing godet rolls to remove the residual DMAc. After washing the fibers were wound onto a bobbin. After the washed fibers were wound onto a bobbin, the fibers were then cut from the bobbin and dried in a 120° C. convection oven under no tension, to allow free shrinkage of the fibers.

Elongations and tenacities were measured using Favimat M in accordance with the DIN 53816 standard. (test conditions: 20 mm gauge length, 10 mm/min strain rate, 0.5 cN/tex pre-tension)

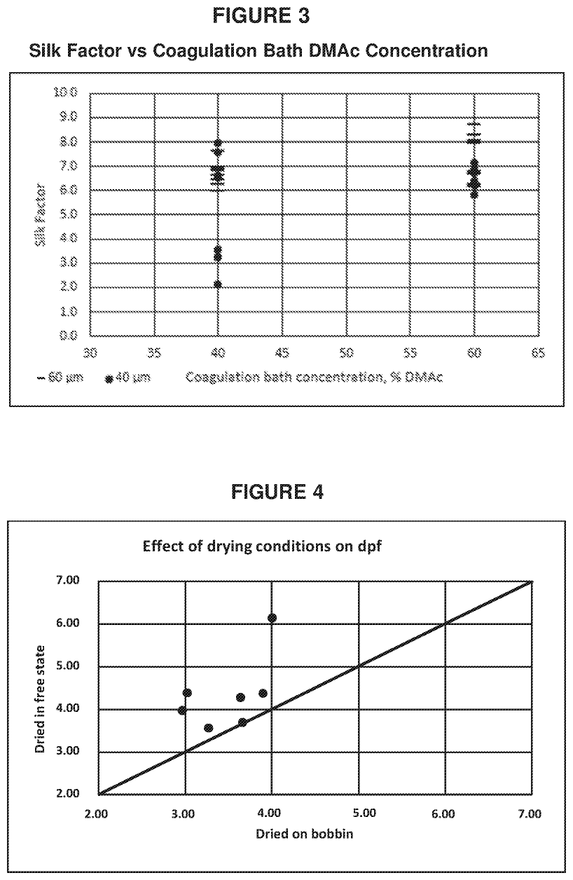

As can be seen in Table 2, silk factors of 8.0 and higher can be produced by the process of the present invention. In this example set, higher jet draw stretching ratios contributed to higher silk factors. FIG. 3 illustrates that optimal coagulation bath concentrations can vary depending on the diameter of the spinneret holes. The highest silk factors produced with the 60 micron holes were all spun into 60% DMAc coagulation bath while 40% DMAc provided the highest silk factor when using the 40 micron holes. Additionally, all of these samples were produced with the samples being dried unrestrained which allowed them to shrink fully during the drying step.

TABLE 2

| | Hole | Coagulation | Stretch bath 1 | | | | | | |
|---|---|---|---|---|---|---|---|---|---|
| | diameter | conc. % | conc. | | | Elongation | Tenacity | Denier | Silk |
| Sample | (micron) | (DMAc/H2O) | (DMAC/H2O) | JDSR | PJDSR | (%) | (g/den) | (g/9000 m) | Factor |
| 13 | 60 | 60/40 | 50/50 | 1.1 | 1 | 44.9 | 1.3 | 5.13 | 8.7 |
| 14 | 60 | 60/40 | 50/50 | 1.1 | 1.16 | 23.8 | 1.7 | 4.39 | 8.3 |
| 15 | 60 | 60/40 | 30/70 | 1.1 | 1 | 39.4 | 1.3 | 5.19 | 8.2 |
| 16 | 60 | 60/40 | 30/70 | 1.1 | 1.16 | 21.9 | 1.7 | 4.25 | 8.0 |
| 17 | 60 | 40/60 | 50/50 | 1.1 | 1 | 29.8 | 1.4 | 4.73 | 7.6 |
| 18 | 60 | 40/60 | 30/70 | 0.7 | 1.00 | 40.2 | 1.1 | 8.72 | 7.0 |
| 19 | 60 | 40/60 | 50/50 | 0.7 | 1.16 | 18.7 | 1.6 | 5.86 | 6.9 |
| 20 | 60 | 40/60 | 50/50 | 0.7 | 1.00 | 39.2 | 1.1 | 8.76 | 6.9 |
| 21 | 60 | 60/40 | 50/50 | 0.7 | 1.16 | 23.4 | 1.4 | 7.02 | 6.8 |
| 22 | 60 | 60/40 | 30/70 | 0.7 | 1.16 | 22.6 | 1.4 | 6.97 | 6.7 |
| 23 | 60 | 40/60 | 50/50 | 1.1 | 1.16 | 15.2 | 1.7 | 4.14 | 6.6 |
| 24 | 60 | 40/60 | 30/70 | 0.7 | 1.16 | 21.1 | 1.4 | 6.88 | 6.4 |
| 25 | 60 | 40/60 | 30/70 | 1.1 | 1 | 27.2 | 1.2 | 4.64 | 6.3 |
| 26 | 60 | 60/40 | 50/50 | 0.7 | 1 | 39.1 | 1 | 8.47 | 6.3 |
| 27 | 60 | 60/40 | 30/70 | 0.7 | 1 | 38 | 1 | 8.07 | 6.2 |
| 28 | 60 | 40/60 | 30/70 | 1.1 | 1.16 | 15.8 | 1.5 | 4.13 | 6.0 |
| 29 | 40 | 40/60 | 50/50 | 0.7 | 1 | 28.1 | 1.5 | 3.56 | 8.0 |
| 30 | 40 | 40/60 | 30/70 | 0.7 | 1 | 33.8 | 1.3 | 4.26 | 7.6 |
| 31 | 40 | 60/40 | 30/70 | 0.7 | 1 | 35.5 | 1.2 | 4.15 | 7.2 |
| 32 | 40 | 60/40 | 50/50 | 0.7 | 1 | 32.8 | 1.2 | 4.18 | 6.9 |
| 33 | 40 | 60/40 | 50/50 | 0.7 | 1.16 | 20.3 | 1.5 | 3.82 | 6.8 |
| 34 | 40 | 60/40 | 30/70 | 0.7 | 1.16 | 20 | 1.5 | 3.86 | 6.7 |
| 35 | 40 | 40/60 | 50/50 | 0.7 | 1.16 | 15.2 | 1.7 | 3.79 | 6.6 |
| 36 | 40 | 40/60 | 30/70 | 0.7 | 1.16 | 14.7 | 1.7 | 3.28 | 6.5 |
| 37 | 40 | 60/40 | 50/50 | 0.4 | 1 | 40.7 | 1 | 6.64 | 6.4 |
| 38 | 40 | 60/40 | 30/70 | 0.4 | 1.16 | 27 | 1.2 | 6.93 | 6.2 |
| 39 | 40 | 60/40 | 50/50 | 0.4 | 1.16 | 22.9 | 1.3 | 5.27 | 6.2 |
| 40 | 40 | 60/40 | 30/70 | 0.4 | 1 | 41.7 | 0.9 | 7.97 | 5.8 |
| 41 | 40 | 40/60 | 30/70 | 0.4 | 1.16 | 12.8 | 1 | 6 | 3.6 |
| 42 | 40 | 40/60 | 30/70 | 0.4 | 1 | 22 | 0.7 | 7.51 | 3.3 |
| 43 | 40 | 40/60 | 50/50 | 0.4 | 1.16 | 12.8 | 0.9 | 6.83 | 3.2 |
| 44 | 40 | 40/60 | 50/50 | 0.4 | 1 | 12.7 | 0.6 | 8.6 | 2.1 |

### Example 3

Dope was prepared using Eastman CTA VM 149 flake (Eastman Chemical Co., Kingsport TN). CTA was dissolved in DMAc at a concentration of 18 wt % CTA. The resulting dope was filtered through a BEKIPOR ST 15AL/3 nonwoven type filter with 15-micron pore size. The filtered dope was fed at a temperature of 90° C. to a spinneret with 60 circular cross section holes each with a diameter of 0.063 mm (63 micron). The spinneret was submerged in a coagulation bath containing a solution of 60 wt % DMAc and 40 wt % water. Upon exiting the spinneret, the fibers passed through the coagulation bath, guided by non-driven guide rolls to a driven take up roll. The jet draw stretching ratio was controlled by adjusting the surface velocity of the driven take up roll relative to the calculated velocity of the dope exiting the spinneret. Samples 0 through 3 were produced with the coagulation bath maintained at 25° C. and samples 4 through 6 were produced with the coagulation bath maintained at 10° C. From the driven take up roll, the fibers were fed to a winder which wound the fibers onto a bobbin. The bobbins were washed by immersion for 10 minutes in an overflow water bath with room temperature water. Following washing, some samples of fiber were cut from the bobbins to be dried unrestrained while other samples were left on the bobbins for drying. These free fiber samples (cut off the bobbins) and the on-bobbin samples were dried in 120° C. air for 15 minutes. Drying fibers on the bobbin constrained the fibers and limited their ability to shrink and relax during drying. Fibers dried in a loose or free state, on the other hand, were allowed to shrink and relax during the drying process.

The mechanical performance of the fibers was evaluated on a FAVIMAT according to ASTM D1577-07 (2018) for denier determinations and ASTM D3822/D3822M-14 (2020) for tenacity and elongation determinations (test conditions: 25 mm gauge length, 15 mm/min strain rate, 0.05 g/denier pre-tension). The silk factor was calculated from the elongation and tenacity results.

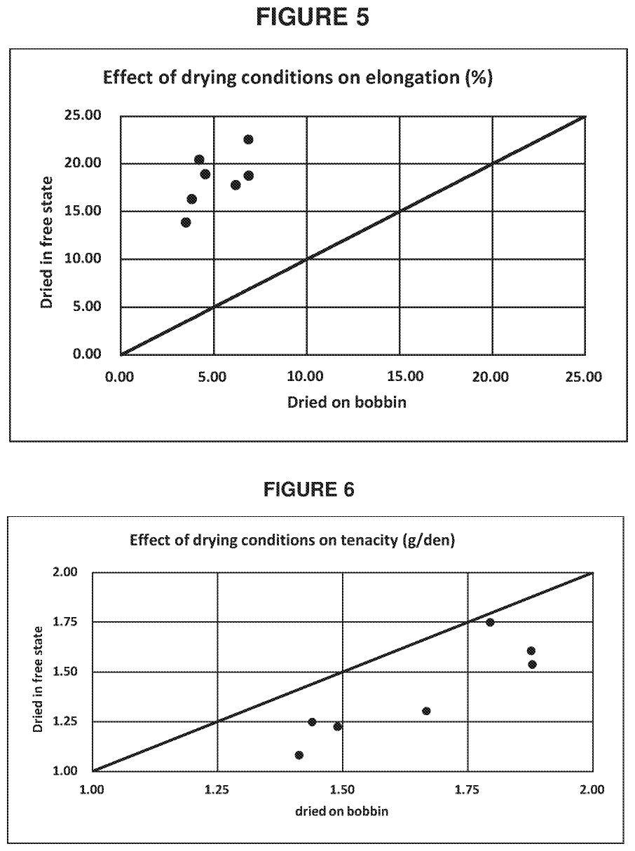

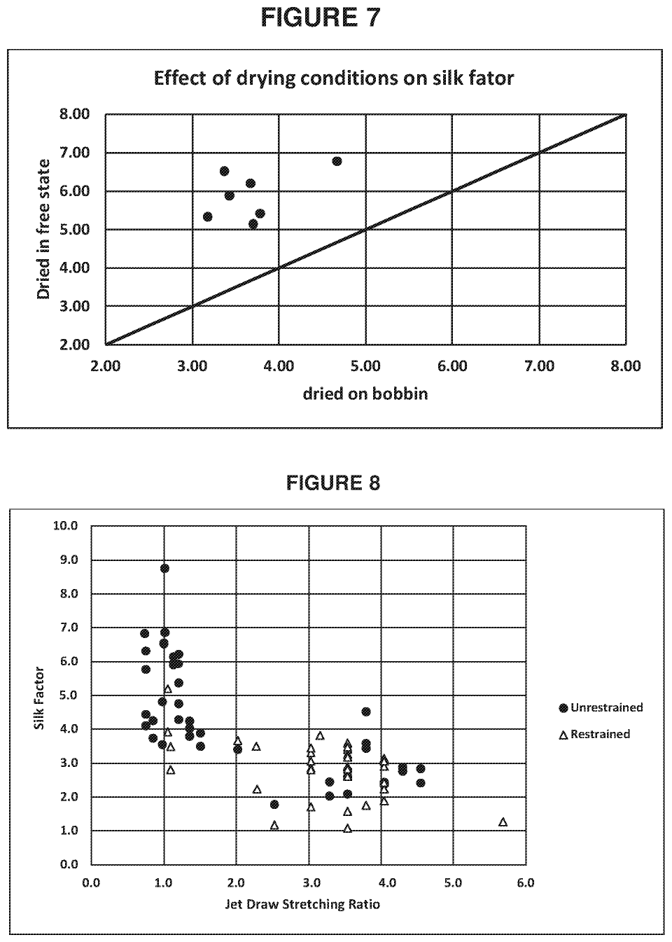

As can be seen in Table 3 and FIGS. 2-5, the drying step of the present invention enables unexpected increases in the tensile properties and silk factor of the CTA fibers produced. Drying the fibers in an unrestrained state allows the fibers to shrink in the longitudinal direction and relax resulting in unexpectedly higher elongations and silk factors when compared to fibers that were restrained during drying by being dried on the bobbin. The resulting silk factors are notably higher for samples dried in the free state.

TABLE 3
Restrained (on bobbin) vs Unrestrained (off bobbin) Drying

| | Spinning conditions | | Property and drying condition | | | | | | | |
|---|---|---|---|---|---|---|---|---|---|---|
| | Coagulation | | denier per | | elongation | | tenacity | | silk | |
| | bath | Jet | filament | | (%) | | (g/den) | | factor | |
| | temperature | draw | On | Off | On | Off | On | Off | On | Off |
| Sample | (C.) | ratio | bobbin | bobbin | bobbin | bobbin | bobbin | bobbin | bobbin | bobbin |
| 0 | 25 | 1.41 | 4.00 | 6.14 | 6.9 | 22.6 | 1.41 | 1.08 | 3.7 | 5.2 |
| 1 | 25 | 1.28 | 3.89 | 4.38 | 6.9 | 18.8 | 1.44 | 1.25 | 3.8 | 5.4 |
| 2 | 25 | 1.19 | 3.63 | 4.28 | 4.5 | 18.9 | 1.49 | 1.23 | 3.2 | 5.3 |
| 3 | 25 | 1.13 | 3.02 | 4.39 | 4.2 | 20.5 | 1.67 | 1.30 | 3.4 | 5.9 |
| 4 | 10 | 1.13 | 2.96 | 3.98 | 3.8 | 16.3 | 1.88 | 1.54 | 3.7 | 6.2 |
| 5 | 10 | 1.19 | 3.27 | 3.57 | 3.5 | 13.9 | 1.80 | 1.75 | 3.4 | 6.5 |
| 6 | 10 | 1.28 | 3.66 | 3.69 | 6.2 | 17.8 | 1.88 | 1.61 | 4.7 | 6.8 |

### Example 4

Cellulose triacetate dopes were prepared by first heating the solvent to the mixing temperature, nominally 90° C., in a glass jar. CTA flake was then added to the heated solvent in the amount required to achieve the target % solids concentration for each experimental condition. Mechanical stirring was applied for 3 hours. The lid of the glass mixing jar had a hole sized to accommodate the shaft of a stirring rod while minimizing solvent evaporation. After mixing, the dope was stored in an oven for one hour at the mixing temperature to allow bubbles to dissipate. The dope was then transferred to another oven and stored at 60 C until testing.

Single filament fiber samples were produced using a benchtop wet spinning line. A syringe pump metered CTA dope to a syringe fitter with either a 60 micron diameter or 110 micron diameter needle submerged in a coagulation bath. The single filament was guided through and out of the coagulation bath by non-driven guide rolls. The temperature, DMAc concentration, and jet draw stretching ratio were varied. The coagulation bath temperature was varied from 11° C. to 20° C., the DMAc concentration from 45 wt % to 60 wt % (based on the weight of all the liquid in the coagulation bath, and the jet draw stretching ratio from 0.7 to 5.7. The jet draw stretching ratio was controlled by varying the surface velocity of the driven winding spool after the coagulation bath relative to the calculated velocity of the dope exiting the spinning needle. No post jet draw stretching ratio was applied. Fiber samples were wound onto a spool using a winder set to the same speed as the take up roll.

After winding, the spool was washed for 5 minutes in room temperature bath of either 100 wt % water or 70 wt % water and 30 wt % DMAc. The samples were dried for 15 minutes at either 60° C. or 110° C. with some of the samples being dried on the bobbin (restrained) while other samples were cut off of the bobbin prior to drying (unrestrained).

The mechanical performance of the fiber samples was evaluated on a FAVIMAT according to ASTM D1577-07 (2018) for denier determinations and ASTM D3822/D3822M-14 (2020) for tenacity and elongation determinations (test conditions: 25 mm gauge length, 15 mm/min strain rate, 0.05 g/denier pre-tension). The silk factor was calculated from the elongation and tenacity results. Results are shown in Table 4.

As can be seen in FIG. 8, the positive effect of unrestrained drying on the silk factor property of a fiber is less significant when the jet draw stretching ratio exceeds 1. (more specifically exceeds 1.4)

TABLE 4

| | Coag. | | CTA | | | Wash | | | | | | |
|---|---|---|---|---|---|---|---|---|---|---|---|---|
| | Bath | | drops | | | Bath | | | Denier | | | |
| | DMAc | Coag. Bath | Spin | Needle | | DMAc | | Drying | per | | | |
| Run | Conc. | Temperature | Temp. | Diameter | | Conc. | Drying | Temp. | filament | Tenacity | Elongation | Silk |
| # | (%) | (C.) | (C.) | (mm) | JDSR | (%) | Conditions | (C.) | (g/900 m) | (gF/den) | % | Factor |
| 1 | 50 | 20 | 90 | 0.11 | 3.0 | 0 | restrained | 60 | 5.3 | 1.0 | 3.12 | 1.7 |
| 2 | 50 | 20 | 90 | 0.11 | 3.5 | 0 | restrained | 60 | 4.4 | 0.9 | 3.2 | 1.6 |
| 3 | 50 | 20 | 90 | 0.11 | 3.8 | 0 | restrained | 60 | 4.3 | 1.0 | 2.9 | 1.8 |
| 16 | 50 | 20 | 60 | 0.11 | 4.0 | 0 | restrained | 60 | 3.7 | 1.2 | 3.3 | 2.2 |
| 18 | 50 | 17 | 60 | 0.11 | 4.0 | 0 | restrained | 60 | 4.1 | 1.2 | 5.67 | 2.9 |
| 21 | 50 | 21 | 60 | 0.11 | 4.0 | 0 | restrained | 60 | 4.6 | 1.0 | 3.3 | 1.9 |
| 25 | 60 | 20 | 60 | 0.11 | 4.0 | 0 | restrained | 60 | 4.3 | 1.2 | 4.29 | 2.4 |
| 47 | 60 | 15 | 60 | 0.11 | 3.5 | 50 | restrained | 60 | 6.0 | 1.1 | 11.3 | 3.6 |
| 48 | 60 | 15 | 60 | 0.11 | 3.5 | 30 | restrained | 60 | 5.2 | 1.1 | 9.8 | 3.4 |
| 49 | 60 | 15 | 60 | 0.11 | 3.5 | 0 | restrained | 60 | 5.3 | 1.1 | 7.6 | 2.9 |
| 50 | 60 | 15 | 60 | 0.11 | 3.0 | 50 | restrained | 60 | 5.0 | 1.1 | 8.9 | 3.3 |
| 51 | 60 | 15 | 60 | 0.11 | 3.0 | 30 | restrained | 60 | 4.7 | 1.1 | 7.3 | 2.9 |
| 52 | 60 | 15 | 60 | 0.11 | 3.0 | 0 | restrained | 60 | 5.4 | 1.1 | 10.4 | 3.5 |
| 53 | 60 | 15 | 60 | 0.11 | 4.0 | 50 | restrained | 60 | 5.3 | 1.1 | 8.9 | 3.1 |
| 57 | 60 | 15 | 60 | 0.11 | 3.5 | 30 | restrained | 60 | 5.4 | 1.0 | 7 | 2.6 |
| 58 | 60 | 15 | 60 | 0.11 | 3.5 | 30 | restrained | 110 | 6.1 | 1.1 | 8.8 | 3.3 |
| 59 | 60 | 15 | 60 | 0.11 | 3.0 | 30 | restrained | 60 | 5.1 | 1.1 | 6.5 | 2.8 |
| 61 | 60 | 15 | 60 | 0.11 | 3.5 | 0 | restrained | 110 | 7.9 | 1.3 | 6.5 | 3.2 |
| 62 | 60 | 15 | 60 | 0.11 | 3.5 | 0 | restrained | 60 | 5.6 | 1.0 | 6.5 | 2.6 |
| 64 | 60 | 15 | 60 | 0.11 | 2.3 | 0 | restrained | 110 | 6.4 | 1.2 | 9.1 | 3.5 |
| 66 | 60 | 12 | 60 | 0.11 | 1.0 | 30 | unrestrained | 60 | 10.1 | 1.8 | 23.4 | 8.8 |
| 67 | 60 | 12 | 60 | 0.11 | 2.0 | 30 | unrestrained | 60 | 7.9 | 0.9 | 13.7 | 3.4 |
| 68 | 60 | 12 | 60 | 0.11 | 1.0 | 30 | unrestrained | 60 | 7.3 | 2.0 | 12 | 6.9 |
| 69 | 60 | 12 | 60 | 0.11 | 2.0 | 30 | restrained | 60 | 7.8 | 0.9 | 15.5 | 3.7 |
| 81 | 45 | 19 | 60 | 0.06 | 1.1 | 30 | restrained | 60 | 5.7 | 1.1 | 13.5 | 3.9 |
| 82 | 45 | 18 | 60 | 0.06 | 1.1 | 30 | restrained | 60 | 4.4 | 1.1 | 7.18 | 2.8 |
| 83 | 45 | 18 | 60 | 0.06 | 2.3 | 30 | restrained | 60 | 3.8 | 1.2 | 3.7 | 2.2 |
| 84 | 45 | 18 | 60 | 0.06 | 3.2 | 30 | restrained | 60 | 5.9 | 1.4 | 7.9 | 3.8 |
| 85 | 45 | 15 | 60 | 0.06 | 1.1 | 30 | restrained | 60 | 4.4 | 1.2 | 17.9 | 5.2 |
| 86 | 45 | 15 | 60 | 0.06 | 1.1 | 30 | restrained | 60 | 5.6 | 1.1 | 9.3 | 3.5 |
| 93 | 45 | 11 | 60 | 0.11 | 3.0 | 30 | restrained | 60 | 8.0 | 1.1 | 8 | 3.1 |
| 94 | 45 | 18 | 60 | 0.11 | 3.5 | 30 | restrained | 60 | 6.6 | 1.1 | 6.1 | 2.8 |
| 95 | 45 | 18 | 60 | 0.11 | 5.7 | 30 | restrained | 60 | 5.5 | 0.8 | 2.3 | 1.3 |
| 99 | 55 | 18 | 60 | 0.11 | 3.0 | 30 | restrained | 60 | 5.6 | 1.1 | 6.5 | 2.8 |
| 100 | 55 | 18 | 60 | 0.11 | 3.5 | 30 | restrained | 60 | 5.4 | 1.2 | 9.2 | 3.5 |
| 101 | 55 | 14 | 60 | 0.11 | 4.0 | 30 | restrained | 60 | 4.9 | 1.2 | 6.5 | 3.1 |
| 150 | 50 | 14 | 60 | 0.11 | 2.5 | 0 | restrained | 60 | 8.0 | 0.5 | 5.1 | 1.2 |
| 151 | 50 | 14 | 60 | 0.11 | 2.5 | 0 | unrestrained | 60 | 9.2 | 0.6 | 8.8 | 1.8 |
| 152 | 50 | 14 | 60 | 0.11 | 3.5 | 0 | restrained | 60 | 7.5 | 0.5 | 4.5 | 1.1 |
| 153 | 50 | 14 | 60 | 0.11 | 3.5 | 0 | unrestrained | 60 | 0.6 | 0.7 | 8.9 | 2.1 |
| 250 | 50 | 14 | 60 | 0.11 | 3.3 | 0 | unrestrained | 60 | 7.1 | 0.7 | 8.4 | 2.0 |
| 251 | 50 | 14 | 60 | 0.11 | 3.3 | 0 | unrestrained | 60 | 6.2 | 0.7 | 11.2 | 2.4 |
| 252 | 50 | 14 | 60 | 0.11 | 3.5 | 0 | unrestrained | 60 | 6.2 | 0.9 | 7.7 | 2.6 |
| 253 | 50 | 14 | 60 | 0.11 | 3.5 | 0 | unrestrained | 60 | 6.0 | 0.8 | 12.5 | 2.8 |
| 254 | 50 | 14 | 60 | 0.11 | 3.8 | 0 | unrestrained | 60 | 4.9 | 1.2 | 9.7 | 3.6 |
| 255 | 50 | 14 | 60 | 0.11 | 3.8 | 0 | unrestrained | 60 | 4.2 | 1.2 | 13.3 | 4.5 |
| 256 | 50 | 14 | 60 | 0.11 | 4.0 | 0 | unrestrained | 60 | 4.7 | 0.9 | 7.4 | 2.4 |
| 257 | 50 | 14 | 60 | 0.11 | 4.0 | 0 | unrestrained | 60 | 5.6 | 0.9 | 7.5 | 2.4 |
| 258 | 50 | 14 | 60 | 0.11 | 4.3 | 0 | unrestrained | 60 | 4.2 | 0.9 | 9.6 | 2.9 |
| 259 | 50 | 14 | 60 | 0.11 | 4.3 | 0 | unrestrained | 60 | 4.7 | 1.0 | 7.8 | 2.8 |
| 260 | 50 | 14 | 60 | 0.11 | 4.5 | 0 | unrestrained | 60 | 4.2 | 0.9 | 9.3 | 2.8 |
| 261 | 50 | 14 | 60 | 0.11 | 4.5 | 0 | unrestrained | 60 | 3.9 | 0.8 | 8.7 | 2.4 |
| 264 | 50 | 14 | 60 | 0.11 | 3.8 | 0 | unrestrained | 60 | 4.9 | 1.1 | 10.7 | 3.4 |
| 280 | 50 | 14 | 60 | 0.06 | 1.0 | 0 | unrestrained | 60 | 4.7 | 1.1 | 10.4 | 3.5 |
| 281 | 50 | 14 | 60 | 0.06 | 1.0 | 0 | unrestrained | 60 | 5.6 | 1.0 | 25.7 | 4.8 |
| 282 | 50 | 14 | 60 | 0.06 | 0.8 | 0 | unrestrained | 60 | 6.6 | 1.0 | 15.9 | 4.1 |
| 283 | 50 | 14 | 60 | 0.06 | 0.8 | 0 | unrestrained | 60 | 5.8 | 1.1 | 17.6 | 4.4 |
| 284 | 50 | 14 | 60 | 0.06 | 0.8 | 0 | unrestrained | 60 | 4.6 | 0.9 | 16.5 | 3.7 |
| 285 | 50 | 14 | 60 | 0.06 | 0.8 | 0 | unrestrained | 60 | 4.1 | 1.1 | 14.4 | 4.3 |
| 286 | 50 | 14 | 60 | 0.06 | 1.2 | 0 | unrestrained | 60 | 4.3 | 1.1 | 14.4 | 4.3 |
| 287 | 50 | 14 | 60 | 0.06 | 1.2 | 0 | unrestrained | 60 | 3.8 | 1.2 | 16.5 | 4.8 |
| 288 | 50 | 14 | 60 | 0.06 | 1.4 | 0 | unrestrained | 60 | 4.1 | 1.1 | 11.7 | 3.8 |
| 289 | 50 | 14 | 60 | 0.06 | 1.4 | 0 | unrestrained | 60 | 3.7 | 1.1 | 13.9 | 4.0 |
| 291 | 50 | 14 | 60 | 0.06 | 1.4 | 0 | unrestrained | 60 | 3.6 | 1.1 | 16 | 4.2 |
| 292 | 50 | 14 | 60 | 0.06 | 1.5 | 0 | unrestrained | 60 | 3.7 | 1.0 | 12.5 | 3.5 |
| 293 | 50 | 14 | 60 | 0.06 | 1.5 | 0 | unrestrained | 60 | 3.3 | 1.1 | 13.7 | 3.9 |
| 320 | 50 | 20 | 60 | 0.06 | 0.8 | 0 | unrestrained | 60 | 5.5 | 1.1 | 34.2 | 6.3 |
| 321 | 50 | 20 | 60 | 0.06 | 0.8 | 0 | unrestrained | 110 | 4.5 | 1.2 | 23.1 | 5.8 |
| 322 | 50 | 20 | 60 | 0.06 | 1.0 | 0 | unrestrained | 60 | 6.1 | 1.1 | 36.1 | 6.5 |
| 323 | 50 | 20 | 60 | 0.06 | 1.0 | 0 | unrestrained | 110 | 3.8 | 1.3 | 26.8 | 6.5 |
| 324 | 50 | 20 | 60 | 0.06 | 1.1 | 0 | unrestrained | 60 | 5.4 | 1.1 | 28.3 | 5.9 |
| 325 | 50 | 20 | 60 | 0.06 | 1.1 | 0 | unrestrained | 110 | 5.4 | 1.2 | 24.2 | 5.9 |
| 326 | 50 | 20 | 60 | 0.06 | 1.2 | 0 | unrestrained | 60 | 4.5 | 1.2 | 29.2 | 6.2 |
| 327 | 50 | 20 | 60 | 0.06 | 1.2 | 0 | unrestrained | 110 | 4.2 | 1.1 | 22.6 | 5.4 |
| 328 | 50 | 20 | 60 | 0.06 | 0.7 | 0 | unrestrained | 60 | 8.2 | 1.2 | 31.8 | 6.8 |
| 329 | 50 | 20 | 60 | 0.06 | 1.0 | 0 | unrestrained | 60 | 6.5 | 1.1 | 38.9 | 6.9 |
| 330 | 50 | 20 | 60 | 0.06 | 1.1 | 0 | unrestrained | 60 | 5.8 | 1.1 | 33.2 | 6.1 |
| 331 | 50 | 20 | 60 | 0.06 | 1.2 | 0 | unrestrained | 60 | 4.3 | 1.2 | 23.4 | 5.9 |

### Example 5

Fiber samples produced according to the method of Example 1 with respect to dope preparation, wet spinning and washing. The samples were then dried for 10 minutes in a convection oven at 120° C., some samples were cut off of the bobbin prior to drying and thus were allowed to shrink (unrestrained) while other samples were dried on the bobbin which did not allow shrinking (restrained). The dried samples were allowed to cool to ambient temperature and select samples were tested for fiber properties. The remaining samples, whether dried restrained or unrestrained, received an additional thermal treatment step placing them in a 180° C. convection oven for 10 minutes. All samples underwent the thermal treatment step in an unrestrained (off the bobbin) state.

Table 5 illustrates the effects drying and annealing processes have on the tensile properties and silk factors of the CTA fibers of the present invention. Drying the fibers in an unrestrained state allows the fibers to relax and shrink, resulting in significantly higher elongations and only slightly lower tenacity compared to fibers that were restrained during drying by drying on the bobbin. The resulting silk factors are also notably higher for samples dried unrestrained. Secondary thermal treatment of the fiber samples that were dried unrestrained results in minor changes to tenacity, elongation, and silk factor. However, secondary thermal treatment of fiber samples that were dried while restrained (on the bobbin) show significant improvements in elongation and silk factor, with little to no change to tenacity. Unexpectedly, the elongation and silk factor properties of the samples that were dried in the restrained state and received the additional thermal treatment step were nearly restored to the levels demonstrated by the fiber samples dried unrestrained. Both unrestrained drying and unrestrained secondary thermal treatment under appropriate temperature and time can effectively relax the fibers, resulting in higher silk factors.

TABLE 5
CTA fiber properties at various drying and annealing conditions

| | Spin | | | | Break | | | |
|---|---|---|---|---|---|---|---|---|
| Sample | Draw | Post Jet | Drying | Thermal | Elong. | Tenacity | Denier | Silk |
| No. | Ratio | Draw Ratio | Condition | Treatment | (%) | (g/den) | (g/9000 m) | Factor |
| 1 | 1.00 | 1.20 | Unrestrained | N/A | 10.37 | 2.15 | 2.53 | 6.91 |
| 2 | 1.00 | 1.20 | Unrestrained | 180° C. | 11.12 | 2.13 | 2.66 | 7.11 |
| | | | | 10 min | | | | |
| 3 | 1.00 | 1.20 | Restrained | No | 4.46 | 2.10 | 2.96 | 4.44 |
| 4 | 1.00 | 1.20 | Restrained | 180° C. | 10.22 | 2.11 | 2.98 | 6.75 |
| | | | | 10 min | | | | |
| 5 | 0.75 | 1.20 | Unrestrained | No | 13.71 | 1.85 | 3.59 | 6.86 |
| 6 | 0.75 | 1.20 | Unrestrained | 180° C. | 14.47 | 1.86 | 3.71 | 7.08 |
| | | | | 10 min | | | | |
| 7 | 0.75 | 1.20 | Restrained | No | 4.05 | 2.00 | 3.13 | 4.02 |
| 8 | 0.75 | 1.20 | Restrained | 180° C. | 10.48 | 2.00 | 3.3 | 6.46 |
| | | | | 10 min | | | | |
| 9 | 0.50 | 1.20 | Unrestrained | No | 14.26 | 1.67 | 4.94 | 6.30 |
| 10 | 0.50 | 1.20 | Unrestrained | 180° C. | 12.5 | 1.75 | 5.32 | 6.19 |
| | | | | 10 min | | | | |
| 11 | 0.50 | 1.20 | Restrained | No | 4.18 | 2.01 | 4.38 | 4.10 |
| 12 | 0.50 | 1.20 | Restrained | 180° C. | 9.88 | 1.87 | 4.60 | 5.89 |
| | | | | 10 min | | | | |

1. A process for producing one or more cellulose triacetate (“CTA”) fibers having a silk factor greater than or equal to 8.0, comprising:
a) a dissolving step wherein cellulose triacetate is dissolved in a dichloromethane-free solvent comprising dimethylacetamide to produce a cellulose triacetate dope;
b) a wet spinning step wherein the cellulose triacetate dope is wet spun through a dichloromethane-free coagulation bath maintained at a temperature ranging from 20° C. to 40° C. to form one or more CTA fibers at a jet draw stretch ratio ranging from 0.3 to 1.4 wherein said bath comprises dimethylacetamide and water; and
c) a drying step wherein the one or more CTA fibers are dried and shrunk in said drying step.

2. The process of claim 1 wherein the one or more CTA fibers have a silk factor greater than or equal to 8.5.

3. The process of claim 1 further comprising a thermal treatment step wherein the one or more fibers are heated to a temperature of at least 10 degrees less than the CTA fiber.

4. The process of claim 1 further comprising at least one post jet draw stretching step wherein the CTA fibers are further stretched to a total post jet draw stretching ratio ranging from 1.0 to 3.0.

5. The process of claim 1 wherein the concentration of dimethylacetamide in the dichloromethane-free coagulation bath is at least 20 weight % and not more than 65 weight % based on the total weight of the coagulation bath.

6. The process of claim 1 wherein the concentration of water in the coagulation bath is at least 35 weight % and not more than 80 weight % based on the total weight of the coagulation bath

7. The process of claim 1 wherein the one or more CTA fibers are partially or completely shrunk in said drying step.

8. The process of claim 3 wherein the thermal treatment step further comprises steam and takes place at a pressure greater than 1 atm.

9. The process of claim 1 further comprising a crimping step.

10. The process of claim 9 wherein said crimping step is followed by a thermal treatment step.

11. The process of claim 1 further comprising a cutting step wherein the one or more CTA fibers are cut into CTA staple fibers.

12. The process of claim 1 further comprising a winding packaging step for continuous fibers.

13. The process of claim 1 wherein the cellulose triacetate has a degree of substitution for acetyl substituents greater than or equal to 2.6.

14. The process of claim 1 wherein the one or more CTA fibers have a denier per filament from 0.5 to not more than 20.

15. The process of claim 1 wherein said cellulose triacetate dope comprises a delustrant.

16. The process of claim 1 wherein the temperature of said cellulose triacetate dope is wet spun at a temperature in the range of 20° C. to not more than 120° C.

17. The cellulose triacetate dope according to claim 16 wherein the cellulose triacetate comprises a DS_{acetyl} of at least 2.6 and a number average degree of polymerization of not more than 200.

18. The cellulose triacetate dope according to claim 17 wherein the cellulose triacetate dope exhibits a viscosity of not more than 1,000 poise when measured at 90° C.

19. A cellulose triacetate fiber produced according to the process of claim 1.

20. The cellulose triacetate fiber of claim 19 wherein the cellulose triacetate comprises a DS_{acetyl} of at least 2.6 and a number average degree of polymerization of not more than 200.
